(19) United States
(12) Patent Application Publication
(10) Pub. No.: US 2026/0071147 A1
(43) Pub. Date: Mar. 12, 2026

(54) FABRIC AND HOME CARE COMPOSITION COMPRISING A POLYALKYLENECARBONATE COMPOUND

(71) Applicant: The Procter & Gamble Company, Cincinnati, OH (US)

(72) Inventors: Carlos AMADOR ZAMARRENO, Newcastle upon Tyne (GB); Xiaobin CHU, Beijing (CN); Brian Joseph LOUGHNANE, Sharonville, OH (US); Laura ORLANDINI, Le Mont-sur-Lausanne (CH); Huesamettin Deniz OEZEREN, Newcastle Upon Tyne (GB); Gang SI, Newcastle upon Tyne (GB); Mu WANG, Cincinnati, OH (US)

(21) Appl. No.: 19/229,027

(22) Filed: Jun. 5, 2025

Related U.S. Application Data
(63) Continuation of application No. PCT/CN2022/136525, filed on Dec. 5, 2022.

(51) Int. Cl. C11D 3/37; C11D 1/06; C11D 1/22; C11D 1/37; C11D 3/00; C11D 3/386; C11D 3/40

(52) U.S. Cl. CPC C11D 3/3715; C11D 1/06; C11D 1/22; C11D 1/37; C11D 3/0036; C11D 3/3707; C11D 3/3723; C11D 3/38618; C11D 3/40; C11D 2111/12

(57) ABSTRACT

The present invention relates to a fabric and home care composition comprising a specific polyalkylenecarbonate compound.

### FIELD OF THE INVENTION

The present invention relates to fabric and home care composition comprising a polyalkylenecarbonate compound.

### BACKGROUND OF THE INVENTION

There is increasing consumer and customer demand for fabric and home care products that are environmentally friendly (“eco-friendly”). For example, in addition to good cleaning performance, many consumers are demanding fabric and home care products that have components that are based on renewable carbon, are biodegradable, have a low carbon footprint, and have lower environmental impact (such as low tendency to accumulate in organisms).

The present invention provides a fabric and home care composition that has advantageous performance in fabric and home care applications and is more environmentally friendly.

The composition of the present invention comprises a specific polyalkylenecarbonate compound.

### SUMMARY OF THE INVENTION

The present invention provides a fabric and home care composition that comprises:
(a) one or more fabric and home care ingredients; and
(b) a polyalkylenecarbonate compound comprises structural unit (II),

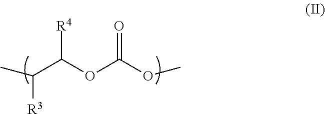

wherein, R³ and R⁴ are each independently selected from H and CH₃.

### BRIEF DESCRIPTION OF THE DRAWINGS

FIG. 1 shows the initial Inventive example system for ST simulation.

FIG. 2 shows the initial Inventive example system for IFT simulation.

### DETAILED DESCRIPTION OF THE INVENTION

### Fabric and Home Care Composition

The fabric and home care composition comprises:
(a) one or more fabric and home care ingredients; and
(b) a polyalkylenecarbonate compound comprises structural unit (II),

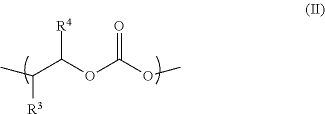

wherein, R³ and R⁴ are each independently selected from H and CH₃.

Preferably, the polyalkylenecarbonate compound has a molecular weight of from 120 to 200000, preferably from 150 to 100000, preferably from 180 to 50000, preferably from 210 to 25000, preferably from 240 to 10000, preferably from 270 to 8000, preferably from 300 to 4000, more preferably from 320 to 2000, most preferably from 350 to 1000.

Preferably, the total weight percentage of CO₂ (CO₂ wt %) in the polyalkylenecarbonate compound is from 5% to 70%, preferably from 10% to 60%, preferably from 15% to 55%, preferably from 20% to 50%, most preferable from 25% to 45%.

Preferably, the polyalkylenecarbonate compound has the following structure

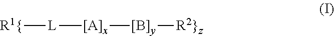

wherein:
R¹ is a residue derived from a starter compound, wherein, the starter compound is selected from monofunctional starter compound comprising from 1 to 4 carbon atoms, difunctional starter compound, multifunctional starter compound.
R² is each independently selected from H, linear or branched, substituted or unsubstituted C₁-C₄ alkyl.
L is selected from O, (C═O)—O.
A has the following structural unit (II)

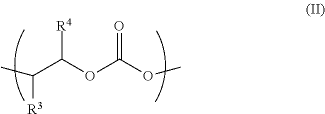

B has the following structural unit (III)

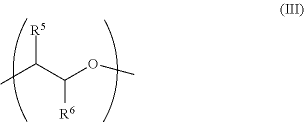

R³, R⁴, R⁵, R⁶ are each independently selected from H and CH₃.
x is integer each independently in the range of 1 to 250.
y is integer each independently in the range of 0 to 250.
z is integer each independently in the range of 1 to 20

Preferably, the composition comprises glycolipids surfactant, preferably selected from sophorolipids surfactant and rhamnolipids surfactant, more preferably mono-rhamnolipid surfactant.

Preferably, the composition comprises surfactant comprising renewable carbon, preferably surfactant selected from:
(a) surfactant comprising a C₈-C₂₂ alkyl chain and a mole average of from 1 to 40 ethoxylate units wherein at least one of the ethoxylate unit or the alkyl chain comprising carbon obtained from carbon capture; and
(b) surfactant comprising a C₈-C₂₀ alkyl chain, wherein the C₈-C₂₀ alkyl chain is produced by genetically engineered cells and microorganisms.

Preferably, the composition comprises alkyl benzene sulphonate (LAS) and/or secondary alkane sulfonate (SAS) surfactant, preferably greater than 50 wt % of the secondary alkane sulfonate is C₁₇ and/or C₁₈ secondary alkane sulfonate.

Preferably, the composition comprises C₁₂-C₁₈ methyl ester ethoxylates, preferably the C₁₂-C₁₈ methyl ester ethoxylates comprises 20% or more C₁₆-C₁₈ methyl ester ethoxylates.

Preferably, the composition comprises one or more surfactant selected from C₁₂ to C₁₈ alkyl ether carboxylates, fatty acid methyl ester sulfonates, furan based anionic surfactant, and citric acid ester of a C₁₆-C₁₈ monoglyceride (citrem), tartartic acid esters of a C₁₆-C₁₈ monoglyceride (tatem) and diacetyl tartaric acid ester of a C₁₆-C₁₈ monoglyceride (datem).

Preferably, the composition comprises a nonionic polyester soil release polymer having a structure according to formula below:

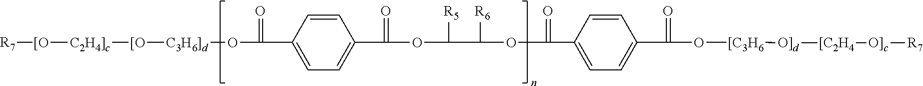

wherein:
R₅ and R₆ is independently selected from H or CH₃. More preferably, one of the R₅ and R₆ is H, and another is CH₃;
c, d are, based on molar average, a number independently selected from 0 to 200, where the sum of c+d is from 2 to 400;
   more preferably, d is from 0 to 50 and c is from 1 to 200;
   more preferably, d is 1 to 10 and c is 5 to 150;
R₇ is C₁-C₄ alkyl, and more preferably methyl;
n is, based on molar average, from 1 to 50, preferably 2-20, more preferably 3-12.

Preferably, the composition comprises a polyester soil release polymer derived from furandicarboxylic acid and/or a derivative thereof.

Preferably, the composition comprises EPEI, where the polyethyleneimine core has an average molecular weight (Mw) ranging from 200 to 5000 g/mol (prior to ethoxylation), and the polyoxyethylene side chains have an average of from 25 to 40 ethoxy units per side chain bonded to the polyethyleneimine backbone. Preferably the polyethyleneimine core has an average molecular weight (Mw) ranging from 1800 to 5000 g/mol (prior to ethoxylation).

Preferably, the composition comprises modified polyamine; preferably, amphoterically-modified oligopropyleneimine ethoxylates.

Preferably, the composition comprises from 0.00001 to 0.5 wt % hueing dye, preferably a hueing dye comprising a chromophore selected from the group consisting of azo, azine, anthraquinone, and triphenylmethane chromophores.

Preferably, the composition comprises a viscosity modifier preferable an ethoxylated sorbitan.

Preferably, the composition further comprises enzyme. comprises one or more selected from proteases, amylases.

Any fabric and home care composition are suitable. Preferred are detergents and cleaning compositions. Especially preferred are fabric treatment compositions, even more preferred are laundry detergent compositions.

Fabric and home care compositions are typically suitable for: (a) the care of finished textiles, cleaning of finished textiles, sanitization of finished textiles, disinfection of finished textiles, detergents, stain removers, softeners, fabric enhancers, stain removal or finished textiles treatments, pre and post wash treatments, washing machine cleaning and maintenance, with finished textiles intended to include garments and items made of cloth; (b) the care of dishes, glasses, crockery, cooking pots, pans, utensils, cutlery and the like in automatic, in-machine washing, including detergents, preparatory post treatment and machine cleaning and maintenance products for both the dishwasher, the utilized water and its contents; or (c) manual hand dish washing detergents.

Laundry Detergent Composition: Suitable laundry detergent compositions include laundry detergent powder compositions, laundry beads, laundry detergent liquid compositions, laundry detergent gel compositions, laundry sheets, and water-soluble unit dose laundry detergent compositions.

Fabric Enhancers: Suitable fabric enhancers are liquid fabric enhancers including compact liquid fabric enhancers, and solid fabric enhancers including fabric enhancer beads.

Dish-washing Detergent Composition: Suitable dish-washing detergent compositions include hand dish-washing detergent compositions and automatic dish-washing detergent compositions. Such as automatic dish-washing powder, tablet and pouches.

Hard Surface Cleaner Compositions: Suitable hard surface cleaner compositions include product that can be directly applied onto hard surface, eg. by a spray, and products that can be diluted in water before been applied onto hard surface. When the fabric and home care composition comprise water, it has a pH of from 2 to 11, preferably from 4 to 9, more preferably from 7 to 8, most preferably from 7 to 8, wherein the pH of the composition is measured at a 10% product concentration in demineralized water at 20° C. In addition, it maybe preferred the water level in the fabric and home care composition is relatively low, such as less than 70%, more preferably less than 40%, more preferably less than 20%, more preferably less than 10%, most preferably less than 5%. Without wish to be bound by theory, it is believed that preferred pH and preferred water level enables the physical and chemical stability of the polyalkylenecarbonate compound in the liquid fabric and home care composition. Therefore, the preferred form of laundry detergent is water-soluble unit dose composition, and highly compacted liquid composition.

Preferably, the fabric and home care composition are in solid form, such as powder, granules, bar, beads, sheet, tablet etc. Typically, these fabric and home care composition in solid form comprise low level of water or moisture content, such as less than 5%, or less than 2%, or preferably less than 1%.

### Polyalkylenecarbonate Compound

The polyalkylenecarbonate compound comprises the following structural unit (II)

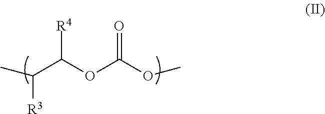

R³ and R⁴ in structure unit (II) are each independently selected from H and CH₃. The polyalkylenecarbonate compound has a molecular weight of from 120 to 200000, preferably from 150 to 100000, preferably from 180 to 50000, preferably from 210 to 25000, preferably from 240 to 10000, preferably from 270 to 8000, preferably from 300 to 4000, more preferably from 320 to 2000, most preferably from 350 to 1000.

Preferably structure unit (II) is derived from copolymerization of alkylene oxide and CO₂. The alkylene oxide are selected from ethylene oxide, propylene oxide and 2,3-butylene oxide. Preferably, the alkylene oxide is selected from ethylene oxide and propylene oxide. The compound maybe synthesized under high pressure in the presence of one or more catalyst. Suitable catalyst comprises double metal cyanide (DMC) catalyst. The synthesis may be a one-step reaction or multi-step reaction. The compound maybe synthesized via reaction of cyclic carbonate with a starter compound in the presence of one or more catalyst.

CO₂ from various known sources maybe used for the synthesis, including waste CO₂ captured from industrial processes, or directly from the atmosphere. The alkylene oxide can be based on fossil carbon or renewable carbon. Renewable carbon is a carbon source that avoid the use of fossil carbon such as natural gas, coal, petroleum. Typically, renewable carbon is derived from the biomass, carbon capture, or chemical recycling.

Typically, the copolymerization is carried out in the presence of a starter compound. The starter compound maybe monofunctional, difunctional, or even multifunctional. The starter compound may also contain other functional groups.

Monofunctional starter compound include, alcohols, carboxylic acids, phenols, amines, thiols. Preferred monofunctional starter compounds are selected from alcohols and carboxylic acids. Preferably, the monofunctional starter compound comprising from 1 to 4 carbon atoms. Typical examples of monofunctional starter alcohol include, but not limit to, methanol, ethanol, propanol, butanol. Typical examples of monofunctional starter carboxylic acid include, but not limit to, formic acid, acetic acid, propionic acid and butyric acid. The monofunctional starter carboxylic acid can be saturated and unsaturated, example of unsaturated monofunctional starter carboxylic acid include acrylic acid, methacrylic acid.

Difunctional starter compound include diol, diacid, polyalkylene glycol. Examples of suitable diol include, but not limit to, ethylene glycol, propylene glycol, butylene glycol, N-phenyldiethanolamine, m-tolyldiethanolamine, any linear or branched, saturated or unsaturated diol C₃-C₂₂ diol. Example of suitable diol also include those contain cyclic structures, such as 1,4-cyclohexanediol, 1,4-cyclohexanedimethanol. Example of suitable acid include oxalic acid, malonic acid, succinic acid, glutaric acid, adipic acid, etc. Examples of suitable polyalkylene glycol include diethylene glycol, dipropylene glycol, triethylene glycol, tripropylene glycol, polyethylene glycol and polypropylene glycol. Suitable polyethylene glycol and polypropylene glycol have a molecular weight of from 200 to 4100, preferably from 300 to 3100, preferably 400 to 2100, more preferably from 500 to 1000.

Multifunctional starter compound include compound which comprises three or more functional groups selected from —OH, —COOH, —SH. Examples of suitable multifunctional starter compound include, but not limit to, citric acid (contains 3 carboxylic acid groups and 1 hydroxyl group), glycerol (contains 3 hydroxyl groups), and sugar alcohols such as sorbitol, mannitol, etc.

The total weight percentage of CO₂ (CO₂ wt %) in the polyalkylenecarbonate compound is from 5% to 70%, preferably from 10% to 60%, preferably from 15% to 55%, preferably from 20% to 50%, most preferable from 25% to 45%. The total weight percentage (wt %) of CO₂ in the polyalkylenecarbonate compound is calculated using the following formula:

$${CO}_{2} wt \% = \frac{averale mole of {CO}_{2} in the compound \times 44}{a v erage molecular weight of the compound} \times 100 \%$$

The polyalkylenecarbonate compound are water soluble. Preferably the polyalkylenecarbonate compound has solubility of more than 1 g/L in DI water (25C). More preferably more than 5 g/L in DI water (25C), most preferably more than 10 g/L in DI water (25C).

Once dissolved DI water, the polyalkylenecarbonate compound may or may not reduce surface tension. In certain embodiment, it maybe preferred the polyalkylenecarbonate compound reduce the surface tension of water to below 60 mN/m, preferably below 50 mN/m, more preferably below 50 mN/m, and more preferably below 40 mN/m, and most preferably below 35 mn/m. The surface tension is measured at concentration of 5000 ppm in DI water.

The polyalkylenecarbonate compound maybe biodegradable or non-biodegradable. Preferably biodegradable.

Preferably, the polyalkylenecarbonate compound has the following structure (I):

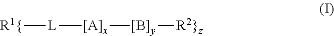

### Wherein,

R¹ is a residue derived from a starter compound, wherein, the starter compound is selected from monofunctional starter compound comprising from 1 to 4 carbon atoms, difunctional starter compound, multifunctional starter compound.
R² is each independently selected from H, linear or branched, substituted or unsubstituted C₁-C₄ alkyl.
L is selected from O, (C═O)—O, a single bond.
A has the following structural unit (II)

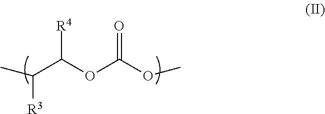

B has the following structural unit (III)

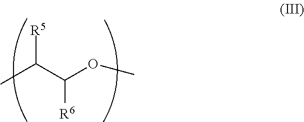

R³, R⁴, R⁵, R⁶ are each independently selected from H and CH₃.
x is integer each independently in the range of 1 to 250.
y is integer each independently in the range of 0 to 250.
z is integer each independently in the range of 1 to 20

Wherein, R¹ is a residue derived from a starter compound selected from monofunctional starter compound comprising from 1 to 4 carbon atoms, difunctional starter compound, multifunctional starter compound as mentioned above.

Preferably the starter compound is selected from difunctional starter compound.

Preferably, x is in the range of 2 to 200, more preferably 3 to 150, more preferably 4 to 100, more preferably 5 to 75, most preferably 5 to 50, most preferably between 1 to 25.

Preferably, y is in the range of 0 to 200, more preferably 2 to 150, more preferably 3 to 100, more preferably 5 to 75, most preferably 5 to 50.

Preferably z is in the range of 1 to 10, more preferably 2 to 5, most preferably z is 2 or 3.

When L is a single bond, R¹ is connected to (II) or (III) from right side as indicated below:

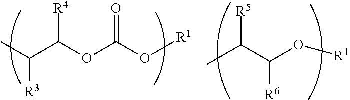

When L is O and/or (C═O)—O, R¹ is connected to the L, and L is further connected to (II) or (III) from the left side as indicated below:

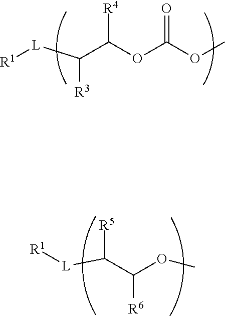

When the polyalkylenecarbonate compound comprise both A structural units and B structural units, it is understood that the A and B structural units can be arranged blockwise, alternating, periodically and/or statistically. It is also understood that both A structural unit and B structural unit can link to the starter group. It is preferred that structural unit A and B of the polyalkylenecarbonate compound are arranged blockwise, such as di-block, tri-block.

Below are some representative examples to clarify meaning of blockwise:

A di-block polyalkylenecarbonate compound containing six A structural units and six B structural units may be represented using structure below:

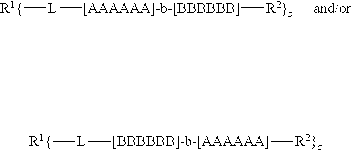

A tri-block polyalkylenecarbonate compound containing six A structural units and six B structural units can be represented with structure below:

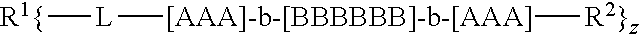

The polyalkylenecarbonate compound has a molecular weight of from 120 to 200000, preferably from 150 to 150000, preferably from 200 to 100000, preferably from 250 to 50000, preferably from 300 to 25000, preferably from 350 to 15000, preferably from 400 to 10000, more preferably from 450 to 9000, most preferably from 500 to 8000, and the polyalkylenecarbonate compound is water soluble.

Preferably, the total weight percentage of CO₂ (CO₂ wt %) in the polyalkylenecarbonate compound is from 5% to 70%, preferably from 10% to 60%, preferably from 15% to 55%, preferably from 20% to 50%, most preferable from 25% to 45%.

In one embodiment, R¹ is a linear or branched, substituted or unsubstituted C₁-C₄ alkyl; R² is H; L is O; z is 1; the polyalkylenecarbonate compound has a structure of (IV):

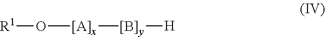

Depend on value of x, y and how A and B are arranged, the compound can be di-block, tri-block, tetra-block and multi-block. Preferably, the compound is di-block and tri-block. Examples di-block compound include (IV-1) to (IV-4):

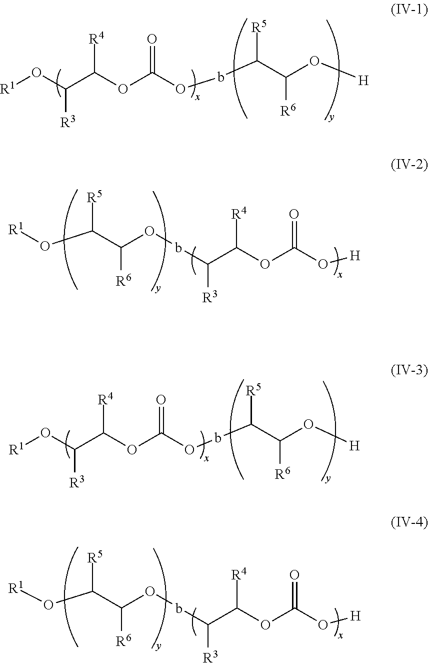

Example of tri-block compound include (IV-5) and (IV-6):

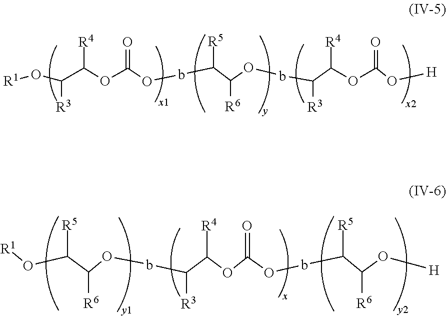

Wherein, x1 and x2 integer each independently of at least 1; x1+x2=x.

In another embodiment, R¹ is a linear or branched C₁-C₄ alkyl; R² is a linear or branched C₁-C₄ alkyl; L is O; z is 1; the polyalkylenecarbonate compound has a structure of (V):

R¹—O—[A]ₓ-[B]_{y}—R² (V)

Depend on value of x, y and how A and B are arranged, the compound can be di-block, tri-block and tetra-block. Preferably, the compound is di-block and tri-block. Examples di-block compound include (V-1) and (V-2):

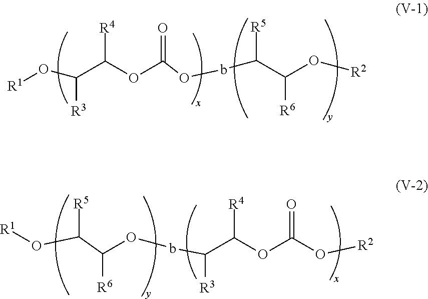

Example of tri-block compound include (V-3) and (V-4):

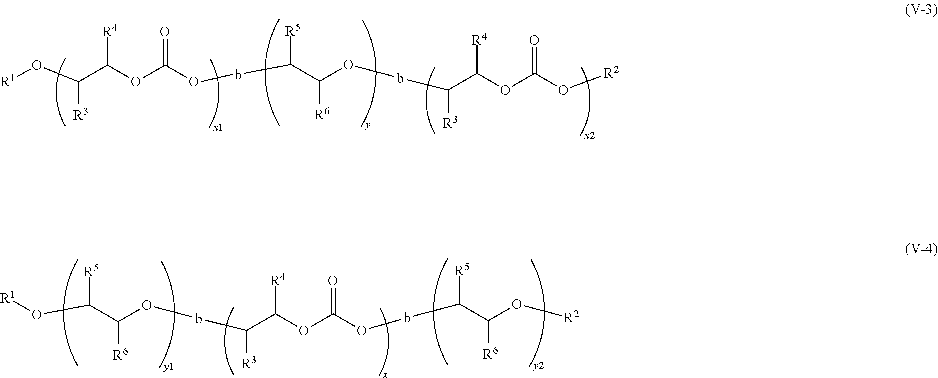

Wherein, x1 and x2 integer each independently of at least 1; x1+x2=x.

Representative examples of R¹ and R² (if R² is not H) and linear and branched, unsubstituted C₁-C₄ alkyl include, methyl, ethyl, n-propyl, n-butyl, isopropyl, isobutyl, t-butyl

One specific example under this embodiment is the following: R¹ is C₁ alkyl(methyl), R² is H, L is O, the polyalkylenecarbonate compound has a structure of (VI-1) or (VI-2):

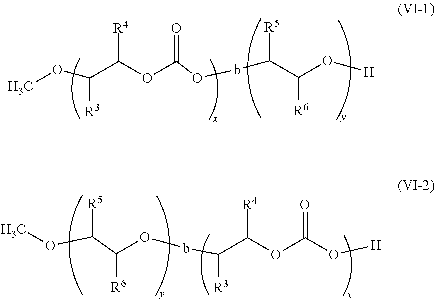

Preferably, polyalkylenecarbonate compound has a structure of (VI-2). Such structure can be derived using polyalkylene glycol mono methyl ether as initiator, preferred mono methyl ether is poly(ethylene glycol) monomethyl ether (mPEG). Preferred mPEG have weight average molecular weight of 200 to 9000, examples include mPEG200, mPEG800, mPEG2000, mPEG 3000, mPEG4000, mPEG5000, mPEG6000, mPEG7000, mPEG8000.

Where total number of x and y is from 2 to 40, preferably from 3 to 30, more preferably from 4 to 20, most preferably from 5 to 50.

Another specific example under this embodiment is the following: R¹ is C₁-C₄ alkyl, R² is H, L is COO, the polyalkylenecarbonate compound has a structure of (VI-3):

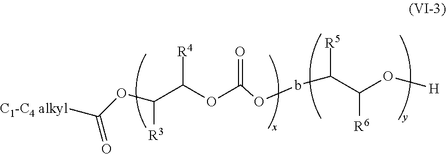

Where total number of x and y is from 2 to 40, preferably from 3 to 30, more preferably from 4 to 20, most preferably from 5 to 50.

In another embodiment, R¹ is derived from a difunctional or multifunctional starter compound; R² is H; L is O and/or (C—O)—O; z is at least 2.

An example polyalkylenecarbonate compound derived from difunctional starter compound has a structure of (VII):

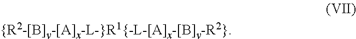

Wherein R¹ is derived from a difunctional starter compound.

Preferably, R¹ is derived from polyalkylene glycol including diethylene glycol, dipropylene glycol, triethylene glycol, tripropylene glycol, polyethylene glycol and polypropylene glycol. More preferably, R¹ is derived from polyethylene glycol or polypropylene glycol have a molecular weight of from 200 to 4100, preferably from 300 to 3100, preferably 400 to 2100, more preferably from 500 to 1000.

When R¹ is selected from polyethylene glycol, the polyalkylenecarbonate compound has a structure of (VII-1)

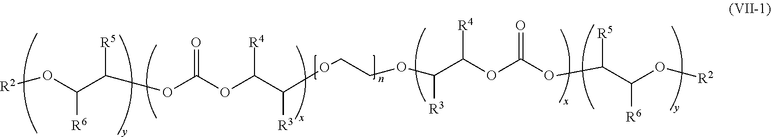

Wherein, n is the number of ethylene glycol units of the polyethylene glycol.

In structure (VII-1), R² is H, C₁-C₄ alkyl, preferably H.

It maybe preferred that R¹ is derived from polypropylene glycol. The structural unit A and B in the structure (VII-1) maybe arranged randomly or blockwise.

An example polyalkylenecarbonate compound derived from multifunctional starter compound has a structure of (VIII):

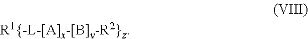

Where z is from 3 to 10, more preferably 3 to 5, most preferably 3, 4, or 5.

Where R¹ is derived from a multifunctional starter compound. Preferred examples of multifunctional starter compound include, but no limit to, glycerol, 1,1,1-trimethylolpropane (TMP), citric acid.

For the present invention, the term “polyalkylenecarbonate” can also be referred as “polyalkylene carbonate” and other terms that represent the same structure. The polyalkylenecarbonate compound of this invention boost cleaning when combine with one or more fabric and home care ingredients in the fabric and home care composition.

Surfactant System: It is highly preferred that the composition comprises a surfactant system in an amount sufficient to provide desired cleaning properties. In some embodiments, the composition comprises, by weight of the composition, from about 1% to about 70% of a surfactant system. In other embodiments, the composition comprises, by weight of the composition, from about 2% to about 60% of the surfactant system. In further embodiments, the composition comprises, by weight of the composition, from about 5% to about 30% of the surfactant system. The surfactant system may comprise a detersive surfactant selected from anionic surfactants, nonionic surfactants, cationic surfactants, zwitterionic surfactants, amphoteric surfactants, ampholytic surfactants, and mixtures thereof. Those of ordinary skill in the art will understand that a detersive surfactant encompasses any surfactant or mixture of surfactants that provide cleaning, stain removing, or laundering benefit to soiled material.

Suitable surfactants include anionic surfactants, non-ionic surfactant, cationic surfactants, zwitterionic surfactants and amphoteric surfactants and mixtures thereof. Suitable surfactants may be linear or branched, substituted or un-substituted, and may be derived from petrochemical material or biomaterial. Preferred surfactant systems comprise both anionic and nonionic surfactant, preferably in weight ratios from 90:1 to 1:90. In some instances a weight ratio of anionic to nonionic surfactant of at least 1:1 is preferred. However, a ratio below 10:1 may be preferred. When present, the total surfactant level is preferably from 0.1% to 60%, from 1% to 50% or even from 5% to 40% by weight of the subject composition.

Suitable surfactant can be based on fossil carbon or renewable carbon. Preferably, the surfactant comprises renewable carbon. Renewable carbon is a carbon source that avoid the use of fossil carbon such as natural gas, coal, petroleum. Typically, renewable carbon is derived from the biomass, carbon capture, or chemical recycling. Preferred example of surfactant comprising renewable carbon are selected from:
(a) surfactant comprising a C₈-C₂₂ alkyl chain and a mole average of from 1 to 40 ethoxylate units, wherein at least one of the ethoxylate unit or the alkyl chain comprising carbon obtained from carbon capture. Example of such surfactant are described in WO2022219118, WO2022219109, WO2022219132, etc.
(b) surfactant comprising a C₈-C₂₀ alkyl chain, wherein the C₈-C₂₀ alkyl chain is produced by genetically engineered cells and microorganisms. Example of such alkyl chains are disclosed in WO2013152051, WO2008119082.
(c) Surfactant which comprising a furan ring or hydrogenated furan ring, where the furan is derived from biomass. Preferred surfactant which comprising a furan ring or hydrogenated furan ring are furan-based anionic surfactant described in WO2022008150. Other preferred surfactant which comprising a furan ring or hydrogenated furan ring are described in WO2018029201, WO2018029202, WO2019042804, WO2019042805.
(d) Glycolipids, glycolipids consisting of a carbohydrate moiety linked to fatty acids, are microbial surface active compounds produced by various microorganisms. Preferably, the glycolipids are selected from sophorolipids surfactant and rhamnolipids surfactant. Rhamnolipids are produced by fermentation of sugar which include mono-rhamnolipids and di-rhamnolipids. Preferred rhamnolipids are mono-rhamnolipids. Particular preferred rhamnolipid described in WO2022229069 and WO2022229052.
(e) Other suitable anionic surfactant includes citric acid ester of a C₁₆-C₁₈ monoglyceride (citrem), tartartic acid esters of a C₁₆-C₁₈ monoglyceride (tatem) and diacetyl tartaric acid ester of a C₁₆-C₁₈ monoglyceride (datem). Suitable surfactants of this class are disclosed in WO2021069516.

Anionic Surfactant: Anionic surfactants include, but are not limited to, those surface-active compounds that contain an organic hydrophobic group containing generally 8 to 22 carbon atoms or generally 8 to 18 carbon atoms in their molecular structure and at least one water-solubilizing group preferably selected from sulfonate, sulfate, and carboxylate so as to form a water-soluble compound. Usually, the hydrophobic group will comprise a C₈-C₂₂ alkyl, or acyl group. Such surfactants are employed in the form of water-soluble salts and the salt-forming cation usually is selected from sodium, potassium, ammonium, magnesium and mono-, with the sodium cation being the usual one chosen.

Anionic surfactants of the present invention and adjunct anionic cosurfactants, may exist in an acid form, and said acid form may be neutralized to form a surfactant salt which is desirable for use in the present detergent compositions. Typical agents for neutralization include the metal counterion base such as hydroxides, e.g., NaOH or KOH. Further preferred agents for neutralizing anionic surfactants of the present invention and adjunct anionic surfactants or cosurfactants in their acid forms include ammonia, amines, oligamines, or alkanolamines. Alkanolamines are preferred. Suitable non-limiting examples including monoethanolamine, diethanolamine, triethanolamine, and other linear or branched alkanolamines known in the art; for example, highly preferred alkanolamines include 2-amino-1-propanol, 1-aminopropanol, monoisopropanolamine, or 1-amino-3-propanol. Amine neutralization may be done to a full or partial extent, e.g. part of the anionic surfactant mix may be neutralized with sodium or potassium and part of the anionic surfactant mix may be neutralized with amines or alkanolamines.

Suitable sulphonate surfactants include methyl ester sulphonates, alpha olefin sulphonates, alkyl benzene sulphonates, especially alkyl benzene sulphonates, preferably C₁₀-C₁₃ alkyl benzene sulphonate. Suitable alkyl benzene sulphonate (LAS) is obtainable, preferably obtained, by sulphonating commercially available linear alkyl benzene (LAB). Suitable LAB includes low 2-phenyl LAB, such as those supplied by Sasol under the tradename Isochem® or those supplied by Petresa under the tradename Petrelab®, other suitable LAB include high 2-phenyl LAB, such as those supplied by Sasol under the tradename Hyblene®. A suitable anionic surfactant is alkyl benzene sulphonate that is obtained by DETAL catalyzed process, although other synthesis routes, such as HF, may also be suitable. In one aspect a magnesium salt of LAS is used.

Preferably, the composition may contain from about 0.5% to about 30%, by weight of the laundry composition, of an HLAS surfactant selected from alkyl benzene sulfonic acids, alkali metal or amine salts of C₁₀-C₁₆ alkyl benzene sulfonic acids, wherein the HLAS surfactant comprises greater than 50% C₁₂, preferably greater than 60%, preferably greater than 70% C₁₂, more preferably greater than 75%.

Suitable sulfonate surfactants also include secondary alkane sulfonate (SAS) surfactant, such surfactant may have a chain length of C₈ to C₂₀. A particular preferred class of SAS surfactant may comprises greater than 50 wt % of C₁₇ and/or C₁₈ secondary alkane sulfonate. Such preferred SAS is described in WO2022042989.

Suitable sulphate surfactants include alkyl sulphate, preferably C₈-18 alkyl sulphate, or predominantly C₁₂ alkyl sulphate.

A preferred sulphate surfactant is alkyl alkoxylated sulphate, preferably alkyl ethoxylated sulphate, preferably a C₈-C₁₈ alkyl alkoxylated sulphate, preferably a C₈-C₁₈ alkyl ethoxylated sulphate, preferably the alkyl alkoxylated sulphate has an average degree of alkoxylation of from 0.5 to 20, preferably from 0.5 to 10, preferably the alkyl alkoxylated sulphate is a C₈-C₁₈ alkyl ethoxylated sulphate having an average degree of ethoxylation of from 0.5 to 10, preferably from 0.5 to 5, more preferably from 0.5 to 3 or from about 1.5 to 3 or from about 1.8 to 2.5. The alkyl alkoxylated sulfate may have a broad alkoxy distribution or a peaked alkoxy distribution. The alkyl portion of the AES may include, on average, from 13.7 to about 16 or from 13.9 to 14.6 carbons atoms. At least about 50% or at least about 60% of the AES molecule may include having an alkyl portion having 14 or more carbon atoms, preferable from 14 to 18, or from 14 to 17, or from 14 to 16, or from 14 to 15 carbon atoms.

The alkyl sulphate, alkyl alkoxylated sulphate and alkyl benzene sulphonates may be linear or branched, including 2 alkyl substituted or mid chain branched type, substituted or un-substituted, and may be derived from petrochemical material or biomaterial. Preferably, the branching group is an alkyl. Typically, the alkyl is selected from methyl, ethyl, propyl, butyl, pentyl, cyclic alkyl groups and mixtures thereof. Single or multiple alkyl branches could be present on the main hydrocarbyl chain of the starting alcohol(s) used to produce the sulfated anionic surfactant used in the detergent of the invention. Most preferably the branched sulfated anionic surfactant is selected from alkyl sulfates, alkyl ethoxy sulfates, and mixtures thereof.

Alkyl sulfates and alkyl alkoxy sulfates are commercially available with a variety of chain lengths, ethoxylation and branching degrees. Commercially available sulfates include those based on Neodol alcohols ex the Shell company, Lial-Isalchem and Safol ex the Sasol company, natural alcohols ex The Procter & Gamble Chemicals company.

Other suitable anionic surfactants include alkyl ether carboxylates, comprising a C₁₀-C₂₆ linear or branched, preferably C₁₀-C₂₀ linear, most preferably C₁₆-C₁₈ linear alkyl alcohol and from 2 to 20, preferably 7 to 13, more preferably 8 to 12, most preferably 9.5 to 10.5 ethoxylates. The acid form or salt form, such as sodium or ammonium salt, may be used, and the alkyl chain may contain one cis or trans double bond. Alkyl ether carboxylic acids are available from Kao (Akypo®), Huntsman (Empicol®) and Clariant (Emulsogen®).

Non-ionic Surfactant: Suitable non-ionic surfactants are selected from the group consisting of: C₈-C₁₈ alkyl ethoxylates, such as, NEODOL® non-ionic surfactants from Shell; C₆-C₁₂ alkyl phenol alkoxylates wherein preferably the alkoxylate units are ethyleneoxy units, propyleneoxy units or a mixture thereof; C₁₂-C₁₈ alcohol and C₆-C₁₂ alkyl phenol condensates with ethylene oxide/propylene oxide block polymers such as Pluronic® from BASF; alkylpolysaccharides, preferably alkylpolyglycosides; methyl ester ethoxylates; polyhydroxy fatty acid amides; ether capped poly(oxyalkylated) alcohol surfactants; and mixtures thereof.

Suitable non-ionic surfactants are alkylpolyglucoside and/or an alkyl alkoxylated alcohol.

Suitable non-ionic surfactants include alkyl alkoxylated alcohols, preferably C₈-C₁₈ alkyl alkoxylated alcohol, preferably a C₈-C₁₈ alkyl ethoxylated alcohol, preferably the alkyl alkoxylated alcohol has an average degree of alkoxylation of from 1 to 50, preferably from 1 to 30, or from 1 to 20, or from 1 to 10, preferably the alkyl alkoxylated alcohol is a C₈-C₁₈ alkyl ethoxylated alcohol having an average degree of ethoxylation of from 1 to 10, preferably from 1 to 7, more preferably from 1 to 5 and most preferably from 3 to 7. In one aspect, the alkyl alkoxylated alcohol is a C₁₂-Cis alkyl ethoxylated alcohol having an average degree of ethoxylation of from 7 to 10. The alkyl alkoxylated alcohol can be linear or branched, and substituted or un-substituted. Suitable nonionic surfactants include those with the trade name Lutensol® from BASF. The alkyl alkoxylated sulfate may have a broad alkoxy distribution for example Alfonic 1214-9 Ethoxylate or a peaked alkoxy distribution for example Novel 1214-9 both commercially available from Sasol

Other suitable non-ionic surfactant include C₁₂ to C₁₈ methyl ester ethoxylates, preferably the C₁₂-C₁₈ methyl ester ethoxylates comprises 20% or more C₁₆-C₁₈ methyl ester ethoxylates. Suitable methyl ester ethoxylates are disclosed in WO2022228945, WO2022228903, WO2022228949, WO2022228950, WO2022228951, WO2022228832.

Cationic Surfactant: Suitable cationic surfactants include alkyl pyridinium compounds, alkyl quaternary ammonium compounds, alkyl quaternary phosphonium compounds, alkyl ternary sulphonium compounds, and mixtures thereof.

Preferred cationic surfactants are quaternary ammonium compounds having the general formula:

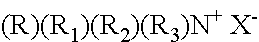

wherein, R is a linear or branched, substituted or unsubstituted C₆₋₁₈ alkyl or alkenyl moiety, R₁ and R₂ are independently selected from methyl or ethyl moieties, R₃ is a hydroxyl, hydroxymethyl or a hydroxyethyl moiety, X is an anion which provides charge neutrality, preferred anions include: halides, preferably chloride; sulphate; and sulphonate.

The fabric care compositions of the present invention may contain up to about 30%, alternatively from about 0.01% to about 20%, more alternatively from about 0.1% to about 20%, by weight of the composition, of a cationic surfactant. For the purposes of the present invention, cationic surfactants include those which can deliver fabric care benefits. Non-limiting examples of useful cationic surfactants include: fatty amines, imidazoline quat materials and quaternary ammonium surfactants, preferably N, N-bis(stearoyl-oxy-ethyl) N,N-dimethyl ammonium chloride, N,N-bis(tallowoyl-oxy-ethyl) N,N-dimethyl ammonium chloride, N,N-bis(stearoyl-oxy-ethyl)N-(2 hydroxyethyl)N-methyl ammonium methylsulfate; 1,2 di(stearoyl-oxy) 3 trimethyl ammoniumpropane chloride; dialkylenedimethylammonium salts such as dicanoladimethylammonium chloride, di(hard) tallowdimethylammonium chloride dicanoladimethylammonium methylsulfate; 1-methyl-1-stearoylamidoethyl-2-stearoylimidazolinium methylsulfate; 1-tallowylamidoethyl-2-tallowylimidazoline; N,N″-dialkyldiethylenetriamine; the reaction product of N-(2-hydroxyethyl)-1,2-ethylenediamine or N-(2-hydroxyisopropyl)-1,2-ethylenediamine with glycolic acid, esterified with fatty acid, where the fatty acid is (hydrogenated) tallow fatty acid, palm fatty acid, hydrogenated palm fatty acid, oleic acid, rapeseed fatty acid, hydrogenated rapeseed fatty acid; polyglycerol esters (PGEs), oily sugar derivatives, and wax emulsions and a mixture of the above. It will be understood that combinations of softener actives disclosed above are suitable for use herein

Amphoteric and Zwitterionic Surfactant: Suitable amphoteric or zwitterionic surfactants include amine oxides, and/or betaines. Preferred amine oxides are alkyl dimethyl amine oxide or alkyl amido propyl dimethyl amine oxide, more preferably alkyl dimethyl amine oxide and especially coco dimethyl amino oxide. Amine oxide may have a linear or mid-branched alkyl moiety. Typical linear amine oxides include water-soluble amine oxides containing one R¹ C₈-C₁₈ alkyl moiety and 2 R² and R³ moieties selected from the group consisting of C₁-C₃ alkyl groups and C₁-C₃ hydroxyalkyl groups. Preferably amine oxide is characterized by the formula R¹—N(R²)(R³)O wherein R¹ is a C₈-C₁₈ alkyl and R² and R³ are selected from the group consisting of methyl, ethyl, propyl, isopropyl, 2-hydroxethyl, 2-hydroxypropyl and 3-hydroxypropyl. The linear amine oxide surfactants in particular may include linear C₁₀-C₁₈ alkyl dimethyl amine oxides and linear C₈-C₁₂ alkoxy ethyl dihydroxy ethyl amine oxides.

Other suitable surfactants include betaines, such as alkyl betaines, alkylamidobetaine, amidazoliniumbetaine, sulfobetaine (INCI Sultaines) as well as Phosphobetaines.

### Fabric and Home Care Ingredients

Suitable fabric and home care ingredients include cleaning additives. Suitable cleaning additives include builders, structurants or thickeners, clay soil removal/anti-redeposition agents, polymeric soil release agents, polymeric dispersing agents, polymeric grease cleaning agents, enzymes, enzyme stabilizing systems, bleaching compounds, bleaching agents, bleach activators, bleach catalysts, brighteners, dyes, hueing agents, dye transfer inhibiting agents, chelating agents, suds supressors, softeners, and perfumes.

Enzymes: Preferably the composition comprises one or more enzymes. Preferred enzymes provide cleaning performance and/or fabric care benefits. Examples of suitable enzymes include, but are not limited to, hemicellulases, peroxidases, proteases, cellulases, xylanases, lipases, phospholipases, esterases, cutinases, pectinases, mannanases, galactanases, pectate lyases, keratinases, reductases, oxidases, phenoloxidases, lipoxygenases, ligninases, pullulanases, tannases, pentosanases, malanases, β-glucanases, arabinosidases, hyaluronidase, chondroitinase, laccase, and amylases, or mixtures thereof. A typical combination is an enzyme cocktail that may comprise, for example, a protease and lipase in conjunction with amylase. When present in the composition, the aforementioned additional enzymes may be present at levels from about 0.00001% to about 2%, from about 0.0001% to about 1% or even from about 0.001% to about 0.5% enzyme protein by weight of the composition.

Proteases. Preferably the composition comprises one or more proteases. Suitable proteases include metalloproteases and serine proteases, including neutral or alkaline microbial serine proteases, such as subtilisins (EC 3.4.21.62). Suitable proteases include those of animal, vegetable or microbial origin. In one aspect, such suitable protease may be of microbial origin. The suitable proteases include chemically or genetically modified mutants of the aforementioned suitable proteases. In one aspect, the suitable protease may be a serine protease, such as an alkaline microbial protease or/and a trypsin-type protease. Examples of suitable neutral or alkaline proteases include:
(a) subtilisins (EC 3.4.21.62), especially those derived from Bacillus, such as Bacillus sp., Bacillus sp., B. lentus, B. alkalophilus, B. subtilis, B. amyloliquefaciens, B. gibsonii, B. akibaii, B. clausii and B. clarkii described in WO2004067737, WO2015091989, WO2015091990, WO2015024739, WO2015143360, U.S. Pat. No. 6,312,936B1, U.S. Pat. Nos. 5,679,630, 4,760,025, DE102006022216A1, DE102006022224A1, WO2015089447, WO2015089441, WO2016066756, WO2016066757, WO2016069557, WO2016069563, WO2016069569, WO2017/089093, WO2020/156419.
(b) trypsin-type or chymotrypsin-type proteases, such as trypsin (e.g., of porcine or bovine origin), including the Fusarium protease described in WO 89/06270 and the chymotrypsin proteases derived from Cellumonas described in WO 05/052161 and WO 05/052146.
(c) metalloproteases, especially those derived from Bacillus amyloliquefaciens described in WO07/044993 A2; from Bacillus, Brevibacillus, Thermoactinomyces, Geobacillus, Paenibacillus, Lysinibacillus or Streptomyces spp. Described in WO2014194032, WO2014194054 and WO2014194117; from Kribella alluminosa described in WO2015193488; and from Streptomyces and Lysobacter described in WO2016075078.

Suitable commercially available protease enzymes include those sold under the trade names Alcalase®, Savinase®, Primase®, Durazym®, Polarzyme®, Kannase®, Liquanase®, Liquanase Ultra®, Savinase Ultra®, Liquanase® Evity®, Savinase® Evity®, Ovozyme®, Neutrase®, Everlase®, Coronase®, Blaze®, Blaze Ultra®, Blaze® Evity®, Blaze® Exceed, Blaze® Pro, Esperase®, Progress® Uno, Progress® Excel, Progress® Key, Ronozyme®, Vinzon® and Het Ultra® by Novozymes A/S (Denmark); those sold under the tradename Maxatase®, Maxacal®, Maxapem®, Properase®, Purafect®, Purafect Prime®, Purafect Ox®, FN3®, FN4®, Excellase®, Ultimase® and Purafect OXP® by Dupont; those sold under the tradename Opticlean® and Optimase® by Solvay Enzymes.

Amylases. Preferably the composition may comprise an amylase. Suitable alpha-amylases include those of bacterial or fungal origin. Chemically or genetically modified mutants (variants) are included. A preferred alkaline alpha-amylase is derived from a strain of Bacillus, such as Bacillus licheniformis, Bacillus amyloliquefaciens, Bacillus stearothermophilus, Bacillus subtilis, or other Bacillus sp. Preferred amylases include:
(a) variants described in WO 94/02597, WO 94/18314, WO96/23874 and WO 97/43424;
(b) variants described in U.S. Pat. No. 5,856,164 and WO99/23211, WO 96/23873, WO00/60060 and WO06/002643;
(c) the wild-type enzyme from Bacillus SP722 in WO06/002643.

Suitable commercially available alpha-amylases include DURAMYL®, LIQUEZYMER, TERMAMYL®, TERMAMYL ULTRAR, NATALASER, SUPRAMYL®, STAINZYME®, STAINZYME PLUS®, FUNGAMYL® and BAN® (Novozymes A/S, Bagsvaerd, Denmark), KEMZYM® AT 9000 Biozym Biotech Trading GmbH Wehlistrasse 27b A-1200 Wien Austria, RAPIDASER, PURASTAR®, ENZYSIZER, OPTISIZE HT PLUS®, POWERASER and PURASTAR OXAM® (Genencor International Inc., Palo Alto, California) and KAM® (Kao, 14-10 Nihonbashi Kayabacho, 1-chome, Chuo-ku Tokyo 103-8210, Japan). In one aspect, suitable amylases include NATALASER, STAINZYMER and STAINZYME PLUS® and mixtures thereof.

Lipases. Preferably the composition comprises one or more lipases, including “first cycle lipases” such as those described in U.S. Pat. No. 6,939,702 B1 and US PA 2009/0217464. Preferred lipases are first-wash lipases. In one embodiment of the invention the composition comprises a first wash lipase.

Preferred lipases would include those sold under the tradenames Lipex® and Lipolex® and Lipoclean®.

Cellulases. Suitable enzymes include cellulases of bacterial or fungal origin. Chemically modified or protein engineered mutants are included. Suitable cellulases include cellulases from the genera Bacillus, Pseudomonas, Humicola, Fusarium, Thielavia, Acremonium, e.g., the fungal cellulases produced from Humicola insolens, Myceliophthora thermophila and Fusarium oxysporum disclosed in U.S. Pat. Nos. 4,435,307, 5,648,263, 5,691,178, 5,776,757 and 5,691,178. Suitable cellulases include the alkaline or neutral cellulases having colour care benefits. Commercially available cellulases include CELLUZYME®, CAREZYME® and CAREZYME PREMIUM (Novozymes A/S), CLAZINASE®, and PURADAX HA® (Genencor International Inc.), and KAC-500 (B)® (Kao Corporation).

The composition may comprise a fungal cleaning cellulase belonging to glycosyl hydrolase family 45 having a molecular weight of from 17 kDa to 30 kDa, for example the endoglucanases sold under the tradename Biotouch® NCD, DCC and DCL (AB Enzymes, Darmstadt, Germany).

Pectate Lyases. Other preferred enzymes include pectate lyases sold under the tradenames Pectawash®, Pectaway®, Xpect® and mannanases sold under the tradenames Mannaway® (all from Novozymes A/S, Bagsvaerd, Denmark), and Purabrite® (Genencor International Inc., Palo Alto, California).

Nucleases. The composition may comprise a nuclease enzyme. The nuclease enzyme is an enzyme capable of cleaving the phosphodiester bonds between the nucleotide sub-units of nucleic acids. The nuclease enzyme herein is preferably a deoxyribonuclease or ribonuclease enzyme or a functional fragment thereof. By functional fragment or part is meant the portion of the nuclease enzyme that catalyzes the cleavage of phosphodiester linkages in the DNA backbone and so is a region of said nuclease protein that retains catalytic activity. Thus, it includes truncated, but functional versions, of the enzyme and/or variants and/or derivatives and/or homologues whose functionality is maintained. Suitable DNases include wild-types and variants described in detail by WO2017162836 and WO2018108865, and variants of the Bacillus cibi DNase including those described in WO2018011277.

RNase: suitable RNases include wild-types and variants of DNases described in WO2018178061 and WO2020074499.

Hexosaminidases. The composition may comprise one or more hexosaminidases. The term hexosaminidase includes “dispersin” and the abbreviation “Dsp”, which means a polypeptide having hexosaminidase activity, EC 3.2.1.-that catalyzes the hydrolysis of β-1,6-glycosidic linkages of N-acetyl-glucosamine polymers found in soils of microbial origin. The term hexosaminidase includes polypeptides having N-acetylglucosaminidase activity and β-N-acetylglucosaminidase activity. Hexosaminidase activity may be determined according to Assay II described in WO2018184873. Suitable hexosaminidases include those disclosed in WO2017186936, WO2017186937, WO2017186943, WO2017207770, WO2018184873, WO2019086520, WO2019086528, WO2019086530, WO2019086532, WO2019086521, WO2019086526, WO2020002604, WO2020002608, WO2020007863, WO2020007875, WO2020008024, WO2020070063, WO2020070249, WO2020088957, WO2020088958 and WO2020207944.

Mannanases. The composition may comprise an extracellular-polymer-degrading enzyme that includes a mannanase enzyme. The term “mannanase” means a polypeptide having mannan endo-1,4-beta-mannosidase activity (EC 3.2.1.78) from the glycoside hydrolase family 26 that catalyzes the hydrolysis of 1,4-3-D-mannosidic linkages in mannans, galactomannans and glucomannans. Alternative names of mannan endo-1,4-beta-mannosidase are 1,4-3-D-mannan mannanohydrolase; endo-1,4-3-mannanase; endo-β-1,4-mannase; β-mannanase B; 3-1,4-mannan 4-mannanohydrolase; endo-3-mannanase; and β-D-mannanase. For purposes of the present disclosure, mannanase activity may be determined using the Reducing End Assay as described in the experimental section of WO2015040159. Suitable examples from class EC 3.2.1.78 are described in WO2015040159.

Galactanases. The composition may comprise an extracellular polymer-degrading enzyme that includes an endo-beta-1,6-galactanase enzyme. The term “endo-beta-1,6-galactanase” or “a polypeptide having endo-beta-1,6-galactanase activity” means a endo-beta-1,6-galactanase activity (EC 3.2.1.164) from the glycoside hydrolase family 30 that catalyzes the hydrolytic cleavage of 1,6-3-D-galactooligosaccharides with a degree of polymerization (DP) higher than 3, and their acidic derivatives with 4-O-methylglucosyluronate or glucosyluronate groups at the non-reducing terminals. For purposes of the present disclosure, endo-beta-1,6-galactanase activity is determined according to the procedure described in WO 2015185689 in Assay I. Suitable examples from class EC 3.2.1.164 are described in WO 2015185689.

Enzyme Stabilizing System: The composition may optionally comprise from about 0.001% to about 10%, in some examples from about 0.005% to about 8%, and in other examples, from about 0.01% to about 6%, by weight of the composition, of an enzyme stabilizing system. The enzyme stabilizing system can be any stabilizing system which is compatible with the detersive enzyme. In the case of aqueous detergent compositions comprising protease, a reversible protease inhibitor, such as a boron compound, including borate, 4-formyl phenylboronic acid, phenylboronic acid and derivatives thereof, or compounds such as calcium formate, sodium formate and 1,2-propane diol may be added to further improve stability.

Builders: The composition may optionally comprise a builder. Built compositions typically comprise at least about 1% builder, based on the total weight of the composition. Liquid compositions may comprise up to about 10% builder, and in some examples up to about 8% builder, of the total weight of the composition. Granular compositions may comprise up to about 30% builder, and in some examples up to about 5% builder, by weight of the composition.

Builders selected from aluminosilicates (e.g., zeolite builders, such as zeolite A, zeolite P, and zeolite MAP) and silicates assist in controlling mineral hardness in wash water, especially calcium and/or magnesium, or to assist in the removal of particulate soils from surfaces. Suitable builders may be selected from the group consisting of phosphates, such as polyphosphates (e.g., sodium tri-polyphosphate), especially sodium salts thereof; carbonates, bicarbonates, sesquicarbonates, and carbonate minerals other than sodium carbonate or sesquicarbonate; organic mono-, di-, tri-, and tetracarboxylates, especially water-soluble nonsurfactant carboxylates in acid, sodium, potassium or alkanolammonium salt form, as well as oligomeric or water-soluble low molecular weight polymer carboxylates including aliphatic and aromatic types; and phytic acid. These may be complemented by borates, e.g., for pH-buffering purposes, or by sulfates, especially sodium sulfate and any other fillers or carriers which may be important to the engineering of stable surfactant and/or builder-containing compositions. Additional suitable builders may be selected from citric acid, lactic acid, fatty acid and salt thereof.

Suitable builders may include polycarboxylate and salt thereof, for example, homopolymers of acrylic acid, copolymers of acrylic acid and maleic acid, and copolymers of acrylic acid and/or maleic acid, and other suitable ethylenic monomers with various types of additional functionalities. More suitable polycarboxylate are described in polycarboxylate polymers section of this patent.

Also suitable for use as builders herein are synthesized crystalline ion exchange materials or hydrates thereof having chain structure and a composition represented by the following general anhydride form: x(M₂O)·ySiO₂·zM′O wherein M is Na and/or K, M′ is Ca and/or Mg; y/x is 0.5 to 2.0; and z/x is 0.005 to 1.0.

Alternatively, the composition may be substantially free of builder.

Structurant/Thickeners: Suitable structurant/thickeners include:
i. Di-benzylidene Polyol Acetal Derivative
ii. Bacterial Cellulose
iii. Coated Bacterial Cellulose
iv. Cellulose fibers non-bacterial cellulose derived
v. Non-Polymeric Crystalline Hydroxyl-Functional Materials
vi. Polymeric Structuring Agents
vii. Di-amido-gellants
viii. Any combination of above.

### Polymers:

The compositions may include one or more polymers. Typically, the level of polymers is from about 0.01% to about 10.0% by weight of the composition, preferably from about 0.1% to about 5%, and more preferably from about 0.2% to about 3.0% by weight of the composition. In some situations where the composition is in concentrated form, such as concentrated fabric and home care products in any forms which designed for consumer to dilute at home and then use following their regular dosing habits, the level of the polymers maybe higher than 10.0%, or higher than 5.0%, by weight of the composition.

Depending on the structure of the polymer, polymers can provide various benefits for the composition, including but not limit to, hydrophobic and hydrophilic stain removal, surfactant boosting, soil suspension, whiteness maintenance, soil release, malodor control, dye transfer inhibition, enhanced softness, enhanced freshness, etc. Polymers are normally multi-functional, which means one specific given type of polymer may provide more than one types of benefit as mentioned above. For example, a specific soil release polymer may provide soil release benefit as primary benefit, while also providing other benefits such as whiteness maintenance, malodor control, soil suspension, dye transfer inhibition.

Suitable polymers including, but not limited to the following:

Graft Polymers Based on Polyalkylene Oxide. The composition may comprise graft polymers which comprising polyalkylene oxide backbone (A) as a graft base and polymeric sidechains (B) grafted thereon. The polymeric sidechains (B) are obtainable by polymerization of at least one vinyl ester monomer. The polyalkylene oxide backbone (A) is obtainable by polymerization of at least one monomers selected from the group of ethylene oxide, 1,2-propylene oxide, 1,2-butylene oxide, 2,3-butylene oxide, 1,2-pentene oxide or 2,3-pentene oxide. Such graft polymers are known as effective soil suspension polymers for hydrophobic and hydrophilic stains, surfactant boosters, and sometimes as dye transfer inhibitors.

Suitable graft polymers include amphilic graft co-polymer comprises polyethylene glycol backbone (A) as a graft base, and at least one pendant sidechains (B) selected from polyvinyl acetate, polyvinyl alcohol and mixtures thereof. A preferred graft polymer of this type is Sokalan HP22 available from BASF.

Suitable graft polymers are also described in WO2007/138053 as amphiphilic graft polymers based on water-soluble polyalkylene oxides (A) as a graft base and side chains formed by polymerization of a vinyl ester component (B), said polymers having an average of <one graft site per 50 alkylene oxide units and mean molar masses M of from 3 000 to 100 000. One specific preferred graft polymer of this type is polyvinyl acetate grafted polyethylene oxide copolymer having a polyethylene oxide as graft base and multiple polyvinyl acetate side chains. The molecular weight of the polyethylene oxide backbone is about 6000 and the weight ratio of the polyethylene oxide to polyvinyl acetate is about 40 to 60 and no more than 1 grafting point per 50 ethylene oxide units. The most preferred polymer of this type is available from BASF as Sokalan PG101.

Suitable graft polymer also include graft polymer comprising a block copolymer backbone (A) as a graft base, wherein said block copolymer backbone (A) is obtainable by polymerization of at least two monomers selected from the group of ethylene oxide, 1,2-propylene oxide, 1,2-butylene oxide, 2,3-butylene oxide, 1,2-pentene oxide or 2,3-pentene oxide, wherein the number (x) of individual blocks within the block copolymer backbone (A) is an integer, wherein x is from 2 to 10 and preferably 3 to 5, and (B) polymeric sidechains grafted onto the block copolymer backbone, wherein said polymeric sidechains (B) are obtainable by polymerization of at least one vinyl ester monomer. Suitable graft polymers of this type are described in WO2021/160795 and WO2021/160851, these polymers have improved biodegradation profiles.

Suitable graft polymer also include graft polymer comprising a polyalkylene oxide backbone (A) which has a number average molecular weight of from about 1000 to about 20,000 Daltons and is based on ethylene oxide, propylene oxide, or butylene oxide; and side chains derived from N-vinylpyrrolidone (B), and side chains derived from vinyl ester (C) derived from a saturated monocarboxylic acid containing from 1 to 6 carbon atoms and/or a methyl or ethyl ester of acrylic or methacrylic acid. Such graft polymers are described in WO2020005476 and can be used as dye transfer inhibitors.

### Modified Polyamine Dispersing Agent

The composition may comprise one or more modified polyamine dispersing agent. The modified polyamine dispersant comprises a polyamine core structure and a plurality of alkoxylate groups attached to the core structure. The polyamine core structure includes polyalkyleneimine, and linear or branched oligoamine.

The polyamine core structure and the alkoxylate groups attached to the core structure can be further derivatized. For example, the polyamine core structure can be further partly or completely quaternized with C₁-C₃₀ linear or branched alkyl, more preferably C₁-C₁₀ or even C₁-C₅ linear or branched alkyl, most preferably methyl. The alkoxylate group can be further sulphated, sulphonated and/or substituted with an amino functional group.

Suitable modified polyamine dispersing agent includes ethoxylated polyethyleneimine (EPEI). EPEI are effective dispersing agent for hydrophilic stains, especially hydrophilic particulate stain such as clay.

In one embodiment, the EPEI has a polyethyleneimine backbone of weight average molecular weight of between 100 g/mol and 2000 g/mol, preferably between 200 g/mol and 1500 g/mol, more preferably between 300 g/mol and 1000 g/mol, even more preferably between 400 g/mol and 800 g/mol, most preferably between 500 g/mol and 700 g/mol, preferably about 600. The ethoxylation chains within the EPEI may be from 200 g/mol to 2000 g/mol weight average molecular weight, preferably from 400 g/mol to 1500 g/mol weight average molecular weight, more preferably from 600 g/mol to 1000 g/mol weight average molecular weight, most preferably about 880 g/mol weight average molecular weight per ethoxylated chain. The ethoxylation chains within the EPEI have on average 5 to 40, preferably 10 to 30, more preferably 15 to 25, even more preferably 18 to 22, most preferably about 20 ethoxy units per ethoxylation chain. The EPEI may have a total weight average molecular weight of from 5000 g/mol to 20000 g/mol, preferably from 7500 g/mol to 17500 g/mol, more preferably from 10000 g/mol to 15000 g/mol, even more preferably from 12000 g/mol to 13000 g/mol, most preferably about 12700 g/mol. A preferred example is polyethyleneimine core (with average molecular weight about 600 g/mol) ethoxylated to 20 EO groups per NH. Suitable EPEI this type includes Sokalan HP20 available from BASF, Lutensol FP620 from BASF. Examples of available polyethyleneimine ethoxylates also include those prepared by reacting ethylene oxide with Epomine SP-006 manufactured by Nippon Shokubai.

In another embodiment, the EPEI comprises polyethyleneimine has an average molecular weight (Mw) ranging from 1800 to 5000 g/mol (prior to ethoxylation), and the polyoxyethylene side chains have an average of from 25 to 40 ethoxy units per side chain bonded to the polyethyleneimine backbone. Such EPEI is described in WO2020/030760 and WO2020/030469.

Suitable modified polyamine dispersing agent includes amphiphilic alkoxylated polyalkyleneimine polymer. These polymers have balanced hydrophilic and hydrophobic properties such that they remove grease and body soil particles from fabrics and surfaces, and keep the particles suspended in washing liquor. Suitable amphiphilic water-soluble alkoxylated polyalkyleneimine polymer is described in WO2009/061990 and WO2006/108857, which comprising in polyalkyleneimine, preferable polyethyleneimine core, and alkoxylate group of below connected to the core

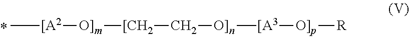

wherein
“*” in each case denotes one-half of bond to the nitrogen atom of the core.
A² is in each case independently selected from 1,2-propylene, 1,2-butylene, and 1,2-isobutylene;
A³ is 1,2-propylene;
R is in each case independently selected from hydrogen and C₁-C₄-alkyl, preferably hydrogen;
m has an average value in the range of from 0 to 2, preferably 0;
n has an average value in the range of 5 to 50; and
p has an average value in the range of 3-50;

The polymer comprising a degree of quaterization ranging from 0 to 50, preferably from 0 to 20, and more preferably from 0 to 10.

A preferred alkoxylated polyalkyleneimine polymer is polyethyleneimine (MW=600) modified with 24 ethoxylate groups per-NH and 16 propoxylate groups per-NH. Another preferred alkoxylated polyalkyleneimine polymer is polyethyleneimine (MW=600) modified with 10 ethoxylate groups per-NH and 7 propoxylate groups per-NH.

Suitable alkoxylated polyalkyleneimine polymer of this type includes Sokalan HP20 Booster available from BASF.

Another Suitable modified polyamine dispersing agent is described in WO2021061774.

Suitable modified polyamine dispersing agent also includes zwitterionic polyamines. Said zwitterionic polyamine is selected from zwitterionic polyamines according to the following formula:

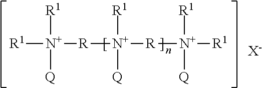

R is each independently C₃-C₂₀ linear or branched alkylene;
R¹ is an anionic unit-capped polyalkyleneoxy unit having the formula: —(R²O)ₓR³, wherein
   R² is C₂-C₄ linear or branched alkylene, preferably C₂ (ethylene);
   R³ is hydrogen, an anionic unit, and mixtures thereof, in which not all R³ groups are hydrogen, preferably wherein R³ anionic units are selected from —(CH₂)ₚCO₂M; —(CH₂)_{q}SO₃M; —(CH₂)_{q}OSO₃M; —(CH₂)_{q}CH(SO₃M)—CH₂SO₃M; —(CH₂)_{q}CH(OSO₃M)CH₂OSO₃M; —(CH₂)_{q}CH(SO₃M)CH₂SO₃M; —(CH₂)ₚPO₃M; —PO₃M; —SO₃M and mixtures thereof; wherein M is hydrogen or a water soluble cation, preferably selected from sodium, potassium, ammonium, and mixtures thereof and in sufficient amount to satisfy charge balance;
   x is from 5 to 50, preferably from 10 to 40, even more preferably from 15 to 30, most preferably from 20 to 25;
Q is a quaternizing unit selected from the group consisting of C₁-C₃₀ linear or branched alkyl, C₆-C₃₀ cycloalkyl, C₇-C₃₀ substituted or unsubstituted alkylenearyl, and mixtures thereof, preferably C₁-C₃₀ linear or branched alkyl, even more preferably C₁-Cio or even C₁-C₅ linear or branched alkyl, most preferably methyl; the degree of quaternization preferably is more than 50%, more preferably more than 70%, even more preferably more than 90%, most preferably about 100;.
X′ is an anion present in sufficient amount to provide electronic neutrality, preferably a water-soluble anion selected from the group consisting of chlorine, bromine, iodine, methylsulfate, and mixtures thereof, more preferably chloride;
n is from 0 to 8, preferably 0 to 4, preferably 0 to 2, most preferably 0.

A suitable zwitterionic polyamine having the following general structure: bis((C₂H₅O)(C₂H₄O)ₙ)(CH₃)—N⁺—CₓH₂ₓ—N⁺—(CH₃)-bis((C₂H₅O)(C₂H₄O)ₙ), wherein n=from 20 to 30, and x=from 3 to 8, or sulphated or sulphonated variants thereof.

A particular preferred zwitterionic polyamine is available from BASF as Lutensit Z96 polymer (zwitterionic hexamethylene diamine according to below formula: 100% quaternized and about 40% of the polyethoxy (EO₂₄) groups are sulfonated). Another particular preferred zwitterionic polyamine is avilable from BASF as Sokalan HP96.

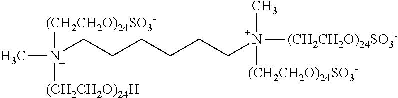

Another suitable zwitterionic polyamine is amphoterically-modified oligopropyleneimine ethoxylates as described in WO2021239547.

Other Polyester Soil Release Polymers. The composition may comprise one or more other polyester soil release polymer (SRP).

Polyester SRP typically have hydrophilic segments to hydrophilize the surface of hydrophobic fibers (such as polyester and nylon), and hydrophobic segments to deposit on hydrophobic fibers and remain adhered thereto through completion of washing and rinsing cycles, thereby serving as an anchor for the hydrophilic segments. This may enable stains occurring subsequent to treatment with a soil release agent to be more easily cleaned in later washing procedures. It is also believed that facilitating the release of soils helps to improve or maintain the wicking properties of a fabric.

The structure of polyester SRP may be tailored to be suitable to use in different detergent or detergent additive products. Soil release polymers may be linear, branched, or star-shaped. Soil release polymers may also include a variety of charged units. Typically, a nonionic SRP or anionic SRP may be particularly preferred when the SRP is used in combination with a detergent which containing anionic surfactants, in order to avoid potentially negative interactions between the SRP and anionic surfactants. Soil release polymer may include an end capping moiety, which is especially effective in controlling the molecular weight of the polymer or altering the physical or surface-adsorption properties of the polymer.

Preferred polyester SRP soil release polymers include terephthalate-derived polyester polymers, which comprise structure unit (I) and/or (II):

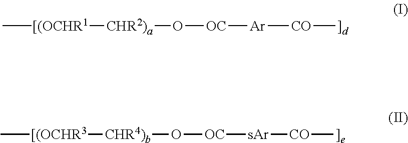

wherein:
a, b are from 1 to 200;
d, e are from 1 to 50;
Ar is independently selected from 1,4-substituted phenylene, and 1,3-substituted phenylene
sAr is 1,3-substituted phenylene substituted in position 5 with —SO₃M; wherein M is a counterion selected from Na, Li, K, Mg/2, Ca/2, Al/3, ammonium, mono-, di-, tri-, or tetraalkylammonium wherein the alkyl groups are C₁-C₁₈ alkyl or C₂-C₁₀ hydroxyalkyl, or mixtures thereof;
R¹, R², R³, R⁴ are independently selected from H or C₁-C₁₈ n-alkyl or iso-alkyl; preferably selected from H or C₁ alkyl.

Optionally, the polymer further comprises one or more terminal group (III) derived from polyalkylene glycolmonoalkylethers, preferably selected from structure (IV-a)

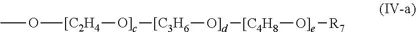

wherein:
R⁷ is a linear or branched C₁-30 alkyl, C₂-C₃₀ alkenyl, or a cycloalkyl group with 5 to 9 carbon atoms, or a C₈-C₃₀ aryl group, or a C₆-C₃₀ arylalkyl group; preferably C₁-4 alkyl, more preferably methyl; and
c, d and e are, based on molar average, a number independently selected from 0 to 200, where the sum of c+d+e is from 2 to 500,
wherein the [C₂H₄—O], [C₃H₆—O] and [C₄H₈—O] groups of the terminal group (IV-a) may be arranged blockwise, alternating, periodically and/or statistically, preferably blockwise and/or statistically, either of the [C₂H₄—O], [C₃H₆—O] and [C₄H₈—O] groups of the terminal group (IV-a) can be linked to —R₇ and/or —O. Preferably, [C₃H₆—O] group is linked to —O, and the —O is further connected to —OC—Ar—CO— or —OC-sAr—CO—.

Optionally, the polymer further comprises one or more anionic terminal unit (IV) and/or (V) as described in EP3222647. Where M is a counterion selected from Na⁺, Li⁺, K⁺, ½ Mg²⁺, ½ Ca²⁺, ⅓ Al³⁺, ammonium, mono-, di-, tri-, or tetraalkylammonium wherein the alkyl groups are C₁-C₁₈ alkyl or C₂-C₁₀ hydroxyalkyl, or mixtures thereof.

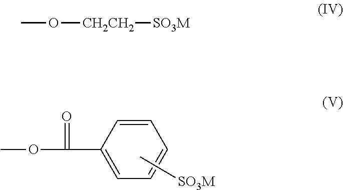

Optionally, the polymer may comprise crosslinking multifunctional structural unit which having at least three functional groups capable of the esterification reaction. The functional which may be for example acid-, alcohol-, ester-, anhydride- or epoxy groups, etc.

Optionally, other di- or polycarboxylic acids or their salts or their (di)alkylesters can be used in the polyesters of the invention, such as, naphthalene-1,4-dicarboxylic acid, naphthalene-2,6,-dicarboxylic acid, tetrahydrophthalic acid, trimellitic acid, diphenoxyethane-4,4′-dicarboxylic acid, diphenyl-4,4′-dicarboxylic acid, 2,5-furandicarboxylic acid, adipic acid, sebacic acid, decan-1,10-dicarboxylic acid, fumaric acid, succinic acid, 1,4-cyclohexanedicarboxylic acid, cyclohexanediacetic acid, glutaric acid, azelaic acid, or their salts or their (di)alkyl esters, preferably their (C₁-C₄)-(di)alkyl esters and more preferably their (di)methyl esters, or mixtures thereof.

One type of preferred polyester SRPs are nonionic polyester SRP, which does not comprise above structure unit (II). A particular preferred nonionic terephthalate-derived soil release polymer has a structure according to formula below:

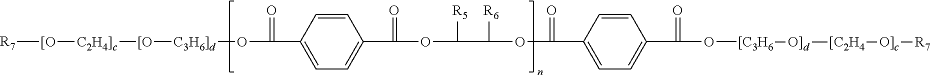

wherein:
R₅ and R₆ is independently selected from H or CH₃. More preferably, one of the R₅ and R₆ is H, and another is CH₃.
c, d are, based on molar average, a number independently selected from 0 to 200, where the sum of c+d is from 2 to 400,
   More preferably, d is from 0 to 50, c is from 1 to 200,
   More preferably, d is 1 to 10, c is 5 to 150,
R₇ is C₁-C₄ alkyl and more preferably methyl,
n is, based on molar average, from 1 to 50.

One example of most preferred above suitable terephthalate-derived nonionic SRP has one of the R₅ and R₆ is H, and another is CH₃; d is 0; c is from 5-100 and R₇ is methyl, and n is from 3-10.

Other suitable terephthalate-derived polyester SRP are described in patent WO2014019903, WO2014019658 and WO2014019659. The end capping group of these SRPs are selected from

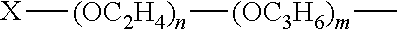

wherein X is C₁-C₄ alkyl and preferably methyl, the —(OC₂H₄) groups and the —(OC₃H₆) groups are arranged blockwise and the block consisting of the —(OC₃H₆) groups is bound to a COO group, n is based on a molar average a number of from 40 to 50, m is based on a molar average a number of from 1 to 10 and preferably of from 1 to 7.

Polyester soil release polymers may be available or convert into different forms, include powder, particle, liquid, waxy or premix. In some embodiment, other materials (for example, water, alcohol, other solvents, salt, surfactant, etc.) are needed to convert the polyester soil release polymer into different forms mentioned above, the wt % of active soil release polymer in the powder, particle, liquid, waxy or premix is in the range from 10% to 100%, for example 15%, 20%, 40%, 60%, 70%, 80%, 90%, 95%, 100%. Useful soil release polymer premix examples are described in EP351759 and WO2022100876. When the soil release polymers exist in liquid or premix from, the premix maybe transparent or opaque, white or slightly yellowish. Premix in opaque maybe use to provide an opaque appearance for the finish product or part of the finish product.

The polyester may or may not be biodegradable, preferred soil release polymers are readily biodegradable.

Example of suitable soil release polymers include TexCare® series supplied by Clariant, including noniconic soil release polymers Texcare® SRN 100, SRN 170, SRN 170 C, SRN 170 Terra, SRN 172, SRN 240, SRN 260, SRN 260 life, SRN 260 SG Terra, SRN UL50, SRN 300, SRN 325; and anionic soil release polymers TexCare® SRA 100, SRA 300, SRA300 F. Example of suitable soil release polymers also include REPEL-O-TEX® line of polymers supplied by Rhodia/Solvay, including nonionic soil release polymer REPEL-O-TEX® Crystal, Crystal PLUS, Crystal NAT, SRP6; and anionic soil release polymer REPEL-O-TEX® SF-2. Other example of commercial soil release polymers also includes WeylClean® series of soil release polymers supplied by WeylChem, including noniconic soil release polymers WeylClean® PLN1, PLN2; and anionic soil release polymers WeylClean® PSA1. Other examples of commercial soil release polymers are Marloquest® polymers, such as Marloquest® SL, HSCB, L235M, U, B, and G82, supplied by Sasol. Further suitable commercial soil release polymers include Sorez 100 (from ISP or Ashland).

Other Soil Release Polymers. The composition may comprise one or more other types of soil release polymer (SRP).

Suitable other soil release polymers of this type include Sokalan® SR400 available from BASF (copolymer of ((2-methacryloyloxy)ethyl)-trimethyl ammonium chloride) as described in WO201828933.

Suitable other soil release polymers also include a copolymer comprising N-isopropylacrylamide units, as described in WO2019197188, WO2019197187, WO2019197185,

WO2019197186.

Particular suitable other soil release polymers also include soil release polymer derived from furandicarboxylic acid and/or a derivative thereof. Particular examples of such soil release polymers are disclosed in WO2019105938, WO2019105939, WO2019096942.

### Polymers Based on Polysaccharide.

Various polysaccharides have proven to be useful starting material to make polymers for fabric and home care products, including cellulose, starch, guar, dextran, polyglucan, chitin, curdlan, xylose, Inulin, pullulan, locust bean gum, cassia gum, tamarind gum (xyloglucan), xanthan gum, amylose, amylopectin, scleroglucan and mixtures thereof.

The most common type of modified polysaccharide is modified cellulose.

Modified cellulose polymers include anionic modified cellulose polymers which been modified with functional groups that contain negative charge. Suitable anionic modified cellulose polymers include carboxyalkyl cellulose, such as carboxymethyl cellulose. In one preferred embodiment, the carboxymethyl cellulose has a degree of carboxymethyl substitution of from about 0.5 to about 0.9 and a molecular weight from about 80,000 Da to about 300,000 Da.

Suitable carboxymethylcellulose is described in WO2011/031599 and WO2009/154933. Suitable carboxymethylcellulose include Finnfix® series sold by CP Kelco or Nouryon, which include Finnfix® GDA, a hydrophobically modified carboxymethylcellulose, e.g., the alkyl ketene dimer derivative of carboxymethylcellulose sold under the tradename Finnfix® SH1, or the blocky carboxymethylcellulose sold under the tradename Finnfix®V. Other suitable anionic modified cellulose polymers include sulphoalkyl group which described in WO2006117056, sulfoethyl cellulose which described in WO2014124872.

Modified cellulose polymers also include nonionic modified cellulose polymers which been modified by functional group that does not contain any charge. Suitable nonionic modified cellulose polymers include alkyl cellulose, hydroxyalkyl cellulose, hydroxyalkyl alkylcellulose, alkylalkoxyalkyl cellulose. Suitable nonionic modified cellulose polymers also include nonionic cellulose carbamates which described in WO2015/044061; nonionic 6-desoxy-6-amino-celluloses derivative which described in US20180346846. Example of alkyl cellulose include methyl cellulose (MC), ethyl cellulose (EC), etc. Suitable ethyl cellulose are sold under tradename Ethocel™ by Dow Chemicals, DuPont, or IFF. Example of hydroxyalkyl cellulose include hydroxyethyl cellulose (HEC) and hydroxypropyl cellulose (HPC). Suitable HEC are sold under tradename Natrosol™ hydroxyethylcellulose by Ashland, such as Natrosol™ 250 with different grade available which has a total molar substitution (MS) of 2.5. Suitable HEC are also sold under tradename CELLOSIZE™ Hydroxyethyl Cellulose by Dow Chemicals. Suitable HPC are sold under tradename Klucel™ by Ashland. Example of hydroxyalkyl alkylcellulose include hydroxypropyl methylcellulose (HPMC), suitable HPMC are sold under tradename Methocel™ with different grade available by Dow Chemicals, DuPont or IFF, and under tradename Benecel™ by Ashland.

Modified cellulose polymers also include cationic modified cellulose polymers which been modified by functional group that contain cationic charge. Suitable cationic modified celluloses include quaternized hydroxyethyl cellulose (Polyquaternium-10), which available under the tradename of Ucare by Dow Chemical, such as Ucare LR400, Ucare LR30M, Ucare JR125, Ucare JR400, etc. Suitable cationic modified cellulose polymers also include quaternized hydroxyethyl cellulose (HEC) polymers with cationic substitution of trimethyl ammonium and dimethyldodecyl ammonium (Polyquaternium-67), which available under trade the tradename of SoftCAT by Dow Chemical, such as SoftCAT SK, SoftCAT SK-MH, SoftCAT SX, SoftCAT SL. Other suitable cationic modified celluloses include those sold under tradename SupraCare™ by Dow Chemical, such as SupraCare™ 150, SupraCare™ 133, SupraCare™ 212.

Suitable cationic modified cellulose polymers also include those modified with cationic group and/or a hydrophobic group and described as soil release polymers in WO2019111948, WO2019111949, WO2019111946 and WO2019111947; suitable polymers is also disclosed in WO2022060754, WO2021242942 and WO2020/091988.

Another common type of modified polysaccharide is modified guar. Similar to modified cellulose, modified guar can be nonionic modified, anionic modified, and cationic modified. Suitable nonionic modified guar includes hydroxypropyl guar, such as N-Hance™ HP40 and HP40S guar available from Ashland. Suitable example of modified guar also include carboxymethyl hydroxypropyl guar (CMHPG) which is anionic and nonionic modified, such as Galactasol™ available from Ashland. Suitable modified guar also includes cationic modified guar, such as guar hydroxypropyltrimonium chloride, which available from by Ashland as AquaCat™ CG518 cationic solution, AquaCat™ PF618 cationic solution, N-Hance™ 3000, 3196, 3215, BF-13, BF-17, C261, C261N, CG13, CCG45. Other cationic modified guar polymers are available from Solvay as Jaguar® C 162, Excel, Excel SGI, Optima, C 13 S, C 13 SH, C14 S, C-17, LS SGI, C-500 STD. Other nonionic and/or anionic modified guar include for example Jaguar® HP 105 (Hydroxypropyl Guar gum), Jaguar® SOFT and HP-120 COS (Carboxymethyl Hydroxypropyl Guar Gum).

Suitable modified polysaccharide polymers also include modified starch. Examples of modified starch include carboxylate ester of starch as described in WO2015144438, esterification product of starch with e.g. C₆-C₂₄ alk(en)yl succinic anhydride as described in EP0703243; starch maleates (starch react with maleic acid anhydride) as described U.S. Pat. No. 6,063,914. Examples of modified starch also include, but not limit to, acetylated starch, acetylated distarch adipate, distarch phosphate, hydroxypropyl starch, hydroxy propyl distarch phosphate, phosphated distarch ohosphate, acetylated distarch phosphate, starch sodium octenyl succinate.

Suitable modified polysaccharide polymers also include polymers based on other polysaccharide, such as cationic dextran polymers described in WO2021194808, the cationic dextran polymers are commercially available under brand name CDC, CDC-L, CDC-H by Meito Sangyo.

Suitable modified polysaccharide polymers also include polymers based on polyglucans. Suitable modified polyglucans are based on alpha 1,3-polyglucans and/or 1,6-polyglucans. In one embodiment, the modified polyglucans can be cationic modified, such as cationic modified alpha 1,3-polyglucan which described in WO2021225837; such as cationic modified alpha 1,6-polyglucans which described in WO2021257793, WO2021257932, and WO2021/257786. In another embodiment, the modified polyglucans can be hydrophobic and/or hydrophilic modified, such as those described in WO2018112187, WO2019246228, WO2019246171, WO2021252558, WO2021252560, WO2021252561, EP3922704, WO2021252569, WO2021252562, WO2021252559, WO2021252575, WO2021252563. Along the hydrophobic and/or hydrophilic modified polyglucans, the polyglucan esters which described in WO2021252562, WO2021252559, WO2021252575, WO2021252563 are especially preferred due to their performance and biodegradability profiles.

Other suitable polysaccharide polymers also include those based on inulin. Example of modified inulin include carboxymethyl group modified inulin (CMI), suitable CMI are Carboxyline series sold by Cosun Beet Company, including Carboxyline 25-40D, Carboxyline 25 D Powder, Carboxyline 20 LS D Powder, Carboxyline 25, Carboxyline 25-30 UP. Example of modified inulin also include cationic modified inulin, suitable cationic modified inulin are as described in US20190274943, US20180119055; suitable cationic modified inulin are Quatin series sold by Cosun Beet Company, including Quatin 350, Quatin 380 and Quatin 1280 which are characterized by different degree of substitution (DS), cationic density (meq/g) and molecular weight (g/mol).

Suitable modified polysaccharide polymers also include polymers based on other polysaccharide, such as xylose carbamates as described in US20210115358; carboxy or sulfo-alkylated pullulan as described in WO2019243072; carboxy- or sulfo-alkylated chitosan as described in WO2019/243108 and WO2021156093.

Polycarboxylate Polymers. The composition may also include one or more polycarboxylate polymers which comprise at least one carboxy group-containing monomer. The carboxy group-containing monomers are selected from acrylic acid, methacrylic acid, fumaric acid, maleic acid, itaconic acid, aconitic acid, mesaconic acid, citraconic acid, methylenemalonic acid, and salts thereof, and anhydride thereof.

Suitable polycarboxylate polymers include polyacrylate homopolymer having a molecular weight of from 4,000 Da to 9,000 Da, or from 6,000 Da to 9,000 Da. Other suitable carboxylate polymers include copolymer of acrylic acid (and/or methacrylic acid) and maleic acid having a molecular weight of from 50,000 Da to 120,000 Da, or from 60,000 Da to 80,000 Da. The polyacrylate homopolymer and copolymer of acrylic acid (and/or methacrylic acid) and maleic acid are commercially available as Acusol 445 and 445N, Acusol 531, Acusol 463, Acusol 448, Acusol 460, Acusol 465, Acusol 497, Acusol 490 from Dow Chemicals, and as Sokalan CP 5, Sokalan CP 7, Sokalan CP 45, and Sokalan CP 12S from BASF. Suitable polycarboxylate polymers also include polyitaconate homopolymers, such as Itaconix® DSP 2KTM sold by Itaconix, and Amaze SP available from Nouryon.

Suitable polycarboxylate polymers also include co-polymers comprising carboxy group-containing monomers and one or more sulfonate or sulfonic group-containing monomers. The sulfonate or sulfonic group containing monomers are selected rom 2-acrylamido-2-methyl-1-propanesulfonic), 2-methacrylamido-2-methyl-1-propanesulfonic acid, 3-methacrylamido-2-hydroxy-propanesulfonic acid, allysulfonic acid, methallysulfonic acid, 3-allyloxy-2-hydroxy-1-propanesulfonic acid, 2-methyl-2-propenen-1-sulfonic acid, styrenesulfonic acid, vinylsulfonic acid, 3-sulfopropyl acrylate, 3-sulfopropylmethacrylate, sulfomethylacrylamide, sulfomethylmethacrylamide and water soluble salts thereof. In one embodiment, suitable polymers comprise maleic acid, acrylic acid, and 3-allyloxy-2-hydroxy-1-propanesulfonic acid, such polymers are as described in U.S. Pat. Nos. 8,450,261 and 8,389,458. In another embodiment, suitable polymers comprise acrylic acid and 2-acrylamido-2-methyl-propane sulfonate, such as those sold under tradename Acusol 588 by Dow Chemicals, Sokalan CP50 by BASF, Aquatreat AR-545, Versaflex 310 and Versaflex 310-37 by Nouryon. In another embodiment, suitable polymers also include Poly(itaconic acid-co-AMPS) sodium salt, such as Itaconix® TSI™ 322 and Itaconix® CHT™ 122 available from Itaconix.

Suitable polymer also includes those contain other structure units in addition to the sulfonate or sulfonic group group-containing monomers and carboxy group-containing monomers. Suitable polymer examples are described in WO2010024468 and WO2014/032267, the additional monomers herein are ether bond-containing monomers represented by formula (1) and (2) below:

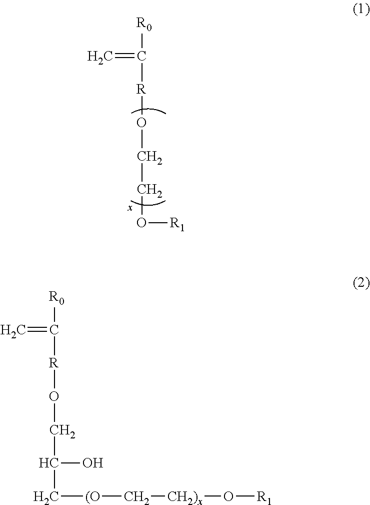

### Wherein in Formula (1)

R₀ represents a hydrogen atom or CH₃ group,
R represents a CH₂ group, CH₂CH₂ group or single bond,
x represents a number 0-50, preferable 0-20, more preferable 0-5 (provided x represents a number 1-5 when R is a single bond), and
R₁ is a hydrogen atom or C₁ to C₂₀ organic group
Wherein in Formula (2), R₀ represents a hydrogen atom or CH₃ group,
R represents a CH₂ group, CH₂CH₂ group or single bond,
x represents a number 0-5, and
R₁ is a hydrogen atom or C₁ to C₂₀ organic group.

A specific preferred polymer of this type comprises structure units derived from 1 to 49 wt % of 1-(allyloxy)-3-butoxypropan-2-ol, from 50 to 98 wt % acrylic acid or methacrylic acid, and from 1 to 49 wt % of 3-allyloxy-2-hydroxy-1-propanesulfonic acid, and the has a weight average molecular weight of from about 20,000 to about 60,000. a specific preferred polymer of this type comprises structure units derived from 1 to 10 wt % of 1-(allyloxy)-3-butoxypropan-2-ol, from 70 to 89 wt % acrylic acid or methacrylic acid, and from 10 to 20 wt % of 3-allyloxy-2-hydroxy-1-propanesulfonic acid, and the has a weight average molecular weight of from about 30,000 to about 60,000. Herein, 1-(allyloxy)-3-butoxypropan-2-ol is a preferred monomer as represented by formula (2) when R₀ is H, R is CH₂, x is 0, and R₁ is n-butyl (C₄-alkyl).

Suitable polycarboxylate polymers also include co-polymers comprising carboxy group-containing monomers and other suitable monomers. Other suitable monomers here are selected from esters and/or amide of the carboxy group-containing monomers, such as C₁-C₂₀ alkyl ester of acrylic acid; alkylene; vinyl ethers, such as methyl vinyl ether, styrene and any mixtures thereof. One specific preferred polymer family of this type is sold under tradename Gantrez by Ashland, which includes Gantrez An (alternating co-polymer of methyl vinyl ether and maleic anhydride), Gantrez S (alternating co-polymer of methyl vinyl ether and maleic acid), Gantrez ES (alternating co-polymer of methyl vinyl ether and maleic acid ester), Gantrez MS (alternating co-polymer of methyl vinyl ether and maleic acid salt).

Suitable polycarboxylate polymers also include polyepoxy succinic acid polymers (PESA). A most preferred polyepoxy succinic acid polymer can be identified using CAS number: 51274-37-4, or 109578-44-1. Suitable polyepoxy succinic acid polymers are commercially available from various suppliers, such as Aquapharm Chemicals Pvt. Ltd (commercial name: Maxinol 600); Shandong Taihe Water Treatment Technologies Co., Ltd (commercial name: PESA), and Sirius International (commercial name: Briteframe PESA).

Suitable polycarboxylate polymers also include polymer comprising a monomer having at least one aspartic acid group or a salt thereof, this polymer comprises at least 25 mol %, 40 mol %, or 50 mol %, of said monomer. A preferabed example is sodium salt of poly(aspartic acid) having a molecular weight of from 2000 to 3000 g/mol which is avilable as Baypure® DS 100 from Lanxess.

Other Polymers. The composition may comprise block polymers of ethylene oxide, propylene oxide and butylene oxide. Examples of such block polymers include ethylene oxide-propylene oxide-ethylene oxide (EO/PO/EO) triblock copolymer, wherein the copolymer comprises a first EO block, a second EO block and PO block wherein the first EO block and the second EO block are linked to the PO block. Blocks of ethylene oxide, propylene oxide, butylene oxide can also be arranged in other ways, such as (EO/PO) diblock copolymer, (PO/EO/PO) triblock copolymer. The block polymers may also contain additional butylene oxide (BO) block. Suitable block polymers are for example Pluronic PE series from BASF, including Pluronic PE3100, PE4300, PE6100, PE6200, PE6400, PE6800, PE8100, PE9200, PE9400, PE10100, PE10500, PE10400. Suitable block polymers also available as Tergitol L series from Dow Chemicals, such as Tergitol L-61, L-62, L-64, L-81, L-101. Due to the hydrophobic and hydrophilic nature, such block polymer sometime is also considered as nonionic surfactant in literature.

The composition may comprise dye transfer inhibiting agents (also called dye transfer inhibitor, or dye fixatives), which include, but are not limited to, polyvinylpyrrolidone polymers (PVP), poly(vinylpyridine-N-oxide) polymer (PVNO), poly(vinylimidazole), polyamine N-oxide polymers, copolymers of N-vinylpyrrolidone and N-vinylimidazole, polyvinyloxazolidones and polyvinylimidazoles or mixtures thereof. dye transfer inhibiting agents may be selected from the group consisting of reaction products of: i) polyamines with cyanamides and organic and/or inorganic acids, ii) cyanamides with aldehydes and ammonium salts, iii) cyanamides with aldehydes and amines, or iv) amines with epichlorohydrin. Preferably, the dye fixative may be selected from the group consisting of reaction products of amines with epichlorohydrin in which the amines are primary, secondary or tertiary amines. More preferably, the dye fixative may be selected from the group consisting of reaction products of dimethylamine with epichlorohydrin. Most preferably, the dye fixative may be poly(2-hydroxypropyldimethylammonium chloride), also called poly(dimethylamine-co-epichlorohydrin), for example the polymer commercially available under the tradename of Texcare DFC 6 pre from Clariant.

The composition may comprise one or more other polymeric dispersing agents. Examples are poly(ethylene glycol), poly(vinyl alcohol).

Suitable polymers can also comprise monomers obtainable from renewable raw materials. Such monomers include monomer below, as described in US20200277548, US20200277549, WO2019096590.

Additional Amines: Additional amines may be used in the compositions described herein for added removal of grease and particulates from soiled materials. The compositions described herein may comprise from about 0.1% to about 10%, in some examples, from about 0.1% to about 4%, and in other examples, from about 0.1% to about 2%, by weight of the composition, of additional amines. Non-limiting examples of additional amines may include, but are not limited to, polyamines, oligoamines, triamines, diamines, pentamines, tetraamines, or combinations thereof. Specific examples of suitable additional amines include tetraethylenepentamine, triethylenetetraamine, diethylenetriamine, or a mixture thereof.

Bleaching Agents. It may be preferred for the composition to comprise one or more bleaching agents. Suitable bleaching agents other than bleaching catalysts include photobleaches, bleach activators, hydrogen peroxide, sources of hydrogen peroxide, pre-formed peracids and mixtures thereof. In general, when a bleaching agent is used, the compositions of the present invention may comprise from about 0.1% to about 50% or even from about 0.1% to about 25% bleaching agent or mixtures of bleaching agents by weight of the subject composition. Examples of suitable bleaching agents include:
(1) photobleaches for example sulfonated zinc phthalocyanine sulfonated aluminium phthalocyanines, xanthene dyes, thioxanthones, and mixtures thereof;
(2) pre-formed peracids: Suitable preformed peracids include, but are not limited to compounds selected from the group consisting of pre-formed peroxyacids or salts thereof typically a percarboxylic acids and salts, percarbonic acids and salts, perimidic acids and salts, peroxymonosulfuric acids and salts, for example, Oxone®, and mixtures thereof.

Particularly preferred peroxyacids are phthalimido-peroxy-alkanoic acids, in particular &-phthalimido peroxy hexanoic acid (PAP). Preferably, the peroxyacid or salt thereof has a melting point in the range of from 30° C. to 60° C.
(3) sources of hydrogen peroxide, for example, inorganic perhydrate salts, including alkali metal salts such as sodium salts of perborate (usually mono- or tetra-hydrate), percarbonate, persulphate, perphosphate, persilicate salts and mixtures thereof. When employed, inorganic perhydrate salts are typically present in amounts of from 0.05 to 40 wt %, or 1 to 30 wt % of the overall fabric and home care product and are typically incorporated into such fabric and home care products as a crystalline solid that may be coated. Suitable coatings include, inorganic salts such as alkali metal silicate, carbonate or borate salts or mixtures thereof, or organic materials such as water-soluble or dispersible polymers, waxes, oils or fatty soaps; and
(4) bleach activators having R-(C—O)—L wherein R is an alkyl group, optionally branched, having, when the bleach activator is hydrophobic, from 6 to 14 carbon atoms, or from 8 to 12 carbon atoms and, when the bleach activator is hydrophilic, less than 6 carbon atoms or even less than 4 carbon atoms; and L is leaving group. Examples of suitable leaving groups are benzoic acid and derivatives thereof-especially benzene sulphonate. Suitable bleach activators include dodecanoyl oxybenzene sulphonate, decanoyl oxybenzene sulphonate, decanoyl oxybenzoic acid or salts thereof, 3,5,5-trimethyl hexanoyloxybenzene sulphonate, tetraacetyl ethylene diamine (TAED) and nonanoyloxybenzene sulphonate (NOBS).
(5) Bleach Catalysts. The compositions of the present invention may also include one or more bleach catalysts capable of accepting an oxygen atom from a peroxyacid and/or salt thereof, and transferring the oxygen atom to an oxidizeable substrate. Suitable bleach catalysts include, but are not limited to: iminium cations and polyions; iminium zwitterions; modified amines; modified amine oxides; N-sulphonyl imines; N-phosphonyl imines; N-acyl imines; thiadiazole dioxides; perfluoroimines; cyclic sugar ketones and alpha amino-ketones and mixtures thereof. One particularly preferred catalyst is acyl hydrazone type such as 4-(2-(2-((2-hydroxyphenylmethyl)methylene)-hydrazinyl)-2-oxoethyl)-4-methylchloride.
(6) The composition may preferably comprise catalytic metal complexes. One preferred type of metal-containing bleach catalyst is a catalyst system comprising a transition metal cation of defined bleach catalytic activity, such as copper, iron, titanium, ruthenium, tungsten, molybdenum, or manganese cations.

If desired, the compositions herein can be catalyzed by means of a manganese compound. Such compounds and levels of use are well known in the art and include, for example, the manganese-based catalysts disclosed in U.S. Pat. No. 5,576,282. In some embodiments, an additional source of oxidant in the composition is not present, molecular oxygen from air providing the oxidative source.

Cobalt bleach catalysts useful herein are known, and are described, for example, in U.S. Pat. Nos. 5,597,936; 5,595,967.

Fluorescent Brightener: Commercial fluorescent brighteners suitable for the present disclosure can be classified into subgroups, including but not limited to: derivatives of stilbene, pyrazoline, coumarin, benzoxazoles, carboxylic acid, methinecyanines, dibenzothiophene-5,5-dioxide, azoles, 5- and 6-membered-ring heterocycles, and other miscellaneous agents. The fluorescent brightener may be selected from the group consisting of disodium 4,4′-bis {[4-anilino-6-morpholino-s-triazin-2-yl]-amino}-2,2′-stilbenedisulfonate (brightener 15, commercially available under the tradename Tinopal AMS-GX by BASF), disodium4,4′-bis {[4-anilino-6-(N-2-bis-hydroxyethyl)-s-triazine-2-yl]-amino}-2,2′-stilbenedisulonate (commercially available under the tradename Tinopal UNPA-GX by BASF), disodium 4,4′-bis {[4-anilino-6-(N-2-hydroxyethyl-N-methylamino)-s-triazine-2-yl]-amino}-2,2′-stilbenedisulfonate (commercially available under the tradename Tinopal 5BM-GX by BASF). More preferably, the fluorescent brightener is disodium 4,4′-bis {[4-anilino-6-morpholino-s-triazin-2-yl]-amino}-2,2′-stilbenedisulfonate or 2,2′-([1,1′-Biphenyl]-4,4′-diyldi-2,1-ethenediyl)bis-benzenesulfonic acid disodium salt. The brighteners may be added in particulate form or as a premix with a suitable solvent, for example nonionic surfactant, propanediol.

Fabric Hueing Agents: The compositions may comprise a fabric hueing agent (sometimes referred to as shading, bluing or whitening agents). Typically, the hueing agent provides a blue or violet shade to fabric. Hueing agents can be used either alone or in combination to create a specific shade of hueing and/or to shade different fabric types. This may be provided for example by mixing a red and green-blue dye to yield a blue or violet shade. Hueing agents may be selected from any known chemical class of dye, including but not limited to acridine, anthraquinone (including polycyclic quinones), azine, azo (e.g., monoazo, disazo, trisazo, tetrakisazo, polyazo), including premetallized azo, benzodifurane and benzodifuranone, carotenoid, coumarin, cyanine, diazahemicyanine, diphenylmethane, formazan, hemicyanine, indigoids, methane, naphthalimides, naphthoquinone, nitro and nitroso, oxazine, phthalocyanine, pyrazoles, stilbene, styryl, triarylmethane, triphenylmethane, xanthenes and mixtures thereof. Preferably, the hueing dye comprising a chromophore selected from the group consisting of azo, azine, anthraquinone, and triphenylmethane chromophores. Suitable shading dye are disclosed in WO2021249927.

Chelating Agent. Preferably the composition comprises chelating agents and/or crystal growth inhibitor. Suitable molecules include copper, iron and/or manganese chelating agents and mixtures thereof. Suitable molecules include hydroxamic acids, aminocarboxylates, aminophosphonates, succinates, salts thereof, and mixtures thereof. Non-limiting examples of suitable chelants for use herein include ethylenediaminetetracetates, N-(hydroxyethyl)ethylenediaminetriacetates, nitrilotriacetates, ethylenediamine tetraproprionates, triethylenetetraaminehexacetates, diethylenetriamine-pentaacetates, ethanoldiglycines, ethylenediaminetetrakis(methylenephosphonates), diethylenetriamine penta(methylene phosphonic acid)(DTPMP), ethylenediamine disuccinate (EDDS), hydroxyethanedimethylenephosphonic acid (HEDP), methylglycinediacetic acid (MGDA), diethylenetriaminepentaacetic acid (DTPA), N,N-Dicarboxymethyl glutamic acid (GLDA) and salts thereof, and mixtures thereof. Other nonlimiting examples of chelants of use in the present invention are found in U.S. Pat. Nos. 7,445,644, 7,585,376 and 2009/0176684A1. Other suitable chelating agents for use herein are the commercial DEQUEST series, and chelants from Monsanto, DuPont, and Nalco, Inc. Yet other suitable chelants include the pyridinyl N Oxide type.

Encapsulates: The compositions may comprise an encapsulate. In some aspects, the encapsulate comprises a core, a shell having an inner and outer surface, where the shell encapsulates the core.

In certain aspects, the encapsulate comprises a core and a shell, where the core comprises a material selected from perfumes; brighteners; dyes; insect repellants; silicones; waxes; flavors; vitamins; fabric softening agents; skin care agents, e.g., paraffins; enzymes; anti-bacterial agents; bleaches; sensates; or mixtures thereof; and where the shell comprises a material selected from polyethylenes; polyamides; polyvinylalcohols, optionally containing other co-monomers; polystyrenes; polyisoprenes; polycarbonates; polyesters; polyacrylates; polyolefins; polysaccharides, e.g., alginate and/or chitosan; gelatin; shellac; epoxy resins; vinyl polymers; water insoluble inorganics; silicone; aminoplasts, or mixtures thereof. In some aspects, where the shell comprises an aminoplast, the aminoplast comprises polyurea, polyurethane, and/or polyureaurethane. The polyurea may comprise polyoxymethyleneurea and/or melamine formaldehyde.

Perfume. Preferred compositions of the invention comprise perfume. Typically the composition comprises a perfume that comprises one or more perfume raw materials, selected from the group as described in WO08/87497. However, any perfume useful in a laundry care composition may be used. A preferred method of incorporating perfume into the compositions of the invention is via an encapsulated perfume particle comprising either a water-soluble hydroxylic compound or melamine-formaldehyde or modified polyvinyl alcohol.

Malodor Reduction Materials. The cleaning compositions of the present disclosure may comprise malodour reduction materials. Such materials are capable of decreasing or even eliminating the perception of one or more malodors. These materials can be characterized by a calculated malodor reduction value (“MORV”), which is calculated according to the test method shown in WO2016/049389.

As used herein “MORV” is the calculated malodor reduction value for a subject material. A material's MORV indicates such material's ability to decrease or even eliminate the perception of one or more malodors.

The cleaning compositions of the present disclosure may comprise a sum total of from about 0.00025% to about 0.5%, preferably from about 0.0025% to about 0.1%, more preferably from about 0.005% to about 0.075%, most preferably from about 0.01% to about 0.05%, by weight of the composition, of 1 or more malodor reduction materials. The cleaning composition may comprise from about 1 to about 20 malodor reduction materials, more preferably 1 to about 15 malodor reduction materials, most preferably 1 to about 10 malodor reduction materials.

One, some, or each of the malodor reduction materials may have a MORV of at least 0.5, preferably from 0.5 to 10, more preferably from 1 to 10, most preferably from 1 to 5. One, some, or each of the malodor reduction materials may have a Universal MORV, defined as all of the MORV values of >0.5 for the malodors tested as described herein. The sum total of malodor reduction materials may have a Blocker Index of less than 3, more preferable less than about 2.5, even more preferably less than about 2, and still more preferably less than about 1, and most preferably about 0. The sum total of malodor reduction materials may have a Blocker Index average of from about 3 to about 0.001.

In the cleaning compositions of the present disclosure, the malodor reduction materials may have a Fragrance Fidelity Index of less than 3, preferably less than 2, more preferably less than 1 and most preferably about 0 and/or a Fragrance Fidelity Index average of 3 to about 0.001 Fragrance Fidelity Index. As the Fragrance Fidelity Index decreases, the malodor reduction material(s) provide less and less of a scent impact, while continuing to counteract malodors. The cleaning compositions of the present disclosure may comprise a perfume. The weight ratio of parts of malodor reduction composition to parts of perfume may be from about 1:20,000 to about 3000:1, preferably from about 1:10,000 to about 1,000:1, more preferably from about 5,000:1 to about 500:1, and most preferably from about 1:15 to about 1:1. As the ratio of malodor reduction composition to parts of perfume is tightened, the malodor reduction material(s) provide less and less of a scent impact, while continuing to counteract malodors.

Conditioning Agents: Suitable conditioning agents include high melting point fatty compounds. The high melting point fatty compound useful herein has a melting point of 25° C. or higher and is selected from the group consisting of fatty alcohols, fatty acids, fatty alcohol derivatives, fatty acid derivatives, and mixtures thereof. Suitable conditioning agents also include nonionic polymers and conditioning oils, such as hydrocarbon oils, polyolefins, and fatty esters.

Suitable conditioning agents include those conditioning agents characterized generally as silicones (e.g., silicone oils, polyoils, cationic silicones, silicone gums, high refractive silicones, and silicone resins), organic conditioning oils (e.g., hydrocarbon oils, polyolefins, and fatty esters) or combinations thereof, or those conditioning agents which otherwise form liquid, dispersed particles in the aqueous surfactant matrix herein. The compositions of the present invention may also comprise from about 0.05% to about 3% of at least one organic conditioning oil as the conditioning agent, either alone or in combination with other conditioning agents, such as the silicones (described herein). Suitable conditioning oils include hydrocarbon oils, polyolefins, and fatty esters.

Probiotics. The composition may comprise probiotics, such as those described in WO2009/043709.

Organic acid. The detergent comprises one or more organic acids selected from the group consisting of acetic acid, adipic acid, aspartic acid, carboxymethyloxymalonic acid, carboxymethyloxysuccinic acid, citric acid, formic acid, glutaric acid, hydroxyethyliminodiacetic acid, iminodiacetic acid, lactic acid, maleic acid, malic acid, malonic acid, oxydiacetic acid, oxydisuccinic acid, succinic acid, sulfamic acid, tartaric acid, tartaric-disuccinic acid, tartaric-monosuccinic acid, or mixtures thereof. Preferably, the detergent composition may comprise an organic acid selected from the group consisting of acetic acid, lactic acid, and citric acid.

Anti-oxidant: The composition may optionally contain an anti-oxidant present in the composition from about 0.001 to about 2% by weight. Preferably the antioxidant is present at a concentration in the range 0.01 to 0.08% by weight. Mixtures of anti-oxidants may be used.

Hygiene Agent: The compositions of the present invention may also comprise components to deliver hygiene and/or malodour benefits such as one or more of zinc ricinoleate, thymol, quaternary ammonium salts such as Bardac®, polyethylenimines (such as Lupasol® from BASF) and zinc complexes thereof, silver and silver compounds, especially those designed to slowly release Ag+or nano-silver dispersions.

The cleaning compositions of the present invention may also contain antimicrobial agents. Preferably, the anti-microbial agent is selected from the group consisting of 4-4′-dichloro-2-hydroxy diphenyl ether (“Diclosan”), 2,4,4′-trichloro-2′-hydroxy diphenyl ether (“Triclosan”), and a combination thereof. Most preferably, the anti-microbial agent is 4-4′-dichloro-2-hydroxy diphenyl ether, commercially available from BASF, under the trademark name Tinosan®HP100.

Pearlescent Agent: Non-limiting examples of pearlescent agents include: mica; titanium dioxide coated mica; bismuth oxychloride; fish scales; mono and diesters of alkylene glycol. The pearlescent agent may be ethyleneglycoldistearate (EGDS).

Opacifier: In one embodiment, the composition might also comprise an opacifier. As the term is used herein, an “opacifier” is a substance added to a material in order to make the ensuing system opaque. In one preferred embodiment, the opacifier is Acusol, which is available from Dow Chemicals. Acusol opacifiers are provided in liquid form at a certain % solids level. As supplied, the pH of Acusol opacifiers ranges from 2.0 to 5.0 and particle sizes range from 0.17 to 0.45 um. In one preferred embodiment, Acusol OP303B and 301 can be used.

In yet another embodiment, the opacifier may be an inorganic opacifier. Preferably, the inorganic opacifier can be TiO₂, ZnO, talc, CaCO₃, and combination thereof. The composite opacifier-microsphere material is readily formed with a preselected specific gravity, so that there is little tendency for the material to separate.

Solvents: The solvent system in the present compositions can be a solvent system containing water alone or mixtures of organic solvents either without or preferably with water.

The compositions may optionally comprise an organic solvent. Suitable organic solvents include C₄-C₁₄ ethers and diethers, glycols, alkoxylated glycols, C₆-C₁₆ glycol ethers, alkoxylated aromatic alcohols, aromatic alcohols, aliphatic branched alcohols, alkoxylated aliphatic branched alcohols, alkoxylated linear C₁-C₅ alcohols, linear C₁-C₅ alcohols, amines, C₈-C₁₄ alkyl and cycloalkyl hydrocarbons and halohydrocarbons, and mixtures thereof. Preferred organic solvents include 1,2-propanediol, 2,3 butane diol, ethanol, glycerol, ethoxylated glycerol, dipropylene glycol, methyl propane diol and mixtures thereof 2 ethyl hexanol, 3,5,5, trimethyl-1 hexanol, and 2 propyl heptanol. Solvents may be a polyethylene or polypropylene glycol ether of glycerin. Other lower alcohols, C₁-C₄ alkanolamines such as monoethanolamine and triethanolamine, can also be used. Solvent systems can be absent, for example from anhydrous solid embodiments of the invention, but more typically are present at levels in the range of from about 0.1% to about 98%, preferably at least about 1% to about 50%, more usually from about 5% to about 25%, alternatively from about 1% to about 10% by weight of the liquid detergent composition of said organic solvent. These organic solvents may be used in conjunction with water, or they may be used without water

Hydrotrope: The composition may optionally comprise a hydrotrope in an effective amount, i.e. from about 0% to 15%, or about 1% to 10%, or about 3% to about 6%, so that compositions are compatible in water. Suitable hydrotropes for use herein include anionic-type hydrotropes, particularly sodium, potassium, and ammonium xylene sulfonate, sodium, potassium and ammonium toluene sulfonate, sodium potassium and ammonium cumene sulfonate, and mixtures thereof, as disclosed in U.S. Pat. No. 3,915,903.

Suds Suppressor. Compounds for reducing or suppressing the formation of suds can be incorporated into the water-soluble unit dose articles. Suds suppression can be of particular importance in the so-called “high concentration cleaning process” and in front-loading style washing machines. Examples of suds supressors include monocarboxylic fatty acid and soluble salts therein, high molecular weight hydrocarbons such as paraffin, fatty acid esters (e.g., fatty acid triglycerides), fatty acid esters of monovalent alcohols, aliphatic C₁₈-C₄₀ ketones (e.g., stearone), N-alkylated amino triazines, waxy hydrocarbons preferably having a melting point below about 100° C., silicone suds suppressors, and secondary alcohols. Preferred fatty acid blends may be mixtures enriched or Fatty acid mixtures enriched with 2-alkyl fatty acid, preferably 2-methyl octanoic acid

Additional suitable antifoams are those derived from phenylpropylmethyl substituted polysiloxanes.

The detergent composition may comprise a suds suppressor selected from organomodified silicone polymers with aryl or alkylaryl substituents combined with silicone resin and a primary filler, which is modified silica. The detergent compositions may comprise from about 0.001% to about 4.0%, by weight of the composition, of such a suds suppressor.

The detergent composition comprises a suds suppressor selected from: a) mixtures of from about 80 to about 92% ethylmethyl, methyl (2-phenylpropyl) siloxane; from about 5 to about 14% MQ resin in octyl stearate; and from about 3 to about 7% modified silica; b) mixtures of from about 78 to about 92% ethylmethyl, methyl (2-phenylpropyl) siloxane; from about 3 to about 10% MQ resin in octyl stearate; from about 4 to about 12% modified silica; or c) mixtures thereof, where the percentages are by weight of the anti-foam.

Liquid Laundry Detergent Composition. The fabric and home care product can be a laundry detergent composition, such as a liquid laundry detergent composition. Suitable liquid laundry detergent compositions can comprise a non-soap surfactant, wherein the non-soap surfactant comprises an anionic non-soap surfactant and a non-ionic surfactant. The laundry detergent composition can comprise from 10% to 60%, or from 20% to 55% by weight of the laundry detergent composition of the non-soap surfactant. The non-soap anionic surfactant to nonionic surfactant are from 1:1 to 20:1, from 1.5:1 to 17.5:1, from 2:1 to 15:1, or from 2.5:1 to 13:1. Suitable non-soap anionic surfactants include linear alkylbenzene sulphonate, alkyl sulphate or a mixture thereof. The weight ratio of linear alkylbenzene sulphonate to alkyl sulphate can be from 1:2 to 9:1, from 1:1 to 7:1, from 1:1 to 5:1, or from 1:1 to 4:1. Suitable linear alkylbenzene sulphonates are C₁₀-C₁₆ alkyl benzene sulfonic acids, or C₁₁-C₁₄ alkyl benzene sulfonic acids. Suitable alkyl sulphate anionic surfactants include alkoxylated alkyl sulphates, non-alkoxylated alkyl sulphates, and mixture thereof. Preferably, the HLAS surfactant comprises greater than 50% C₁₂, preferably greater than 60%, preferably greater than 70% C₁₂, more preferably greater than 75% C₁₂. Suitable alkoxylated alkyl sulphate anionic surfactants include ethoxylated alkyl sulphate anionic surfactants. Suitable alkyl sulphate anionic surfactants include ethoxylated alkyl sulphate anionic surfactant with a mol average degree of ethoxylation of from 1 to 5, from 1 to 3, or from 2 to 3. The alkyl alkoxylated sulfate may have a broad alkoxy distribution or a peaked alkoxy distribution. The alkyl portion of the AES may include, on average, from 13.7 to about 16 or from 13.9 to 14.6 carbons atoms. At least about 50% or at least about 60% of the AES molecule may include having an alkyl portion having 14 or more carbon atoms, preferable from 14 to 18, or from 14 to 17, or from 14 to 16, or from 14 to 15 carbon atoms. The alkyl sulphate anionic surfactant may comprise a non-ethoxylated alkyl sulphate and an ethoxylated alkyl sulphate wherein the mol average degree of ethoxylation of the alkyl sulphate anionic surfactant is from 1 to 5, from 1 to 3, or from 2 to 3. The alkyl fraction of the alkyl sulphate anionic surfactant can be derived from fatty alcohols, oxo-synthesized alcohols, Guerbet alcohols, or mixtures thereof. Preferred alkyl sulfates include optionally ethoxylated alcohol sulfates including 2-alkyl branched primary alcohol sulfates especially 2-branched C₁₂-C₁₅ primary alcohol sulfates, linear primary alcohol sulfates especially linear C₁₂-C₁₄ primary alcohol sulfates, and mixtures thereof. The laundry detergent composition can comprise from 10% to 50%, or from 15% to 45%, or from 20% to 40%, or from 30% to 40% by weight of the laundry detergent composition of the non-soap anionic surfactant.

Suitable non-ionic surfactants can be selected from alcohol broad or narrow range alkoxylates, an oxo-synthesised alcohol alkoxylate, Guerbet alcohol alkoxylates, alkyl phenol alcohol alkoxylates, or a mixture thereof. The laundry detergent composition can comprise from 0.01% to 10%, from 0.01% to 8%, from 0.1% to 6%, or from 0.15% to 5% by weight of the liquid laundry detergent composition of a non-ionic surfactant.

The laundry detergent composition comprises from 1.5% to 20%, or from 2% to 15%, or from 3% to 10%, or from 4% to 8% by weight of the laundry detergent composition of soap, such as a fatty acid salt. Such soaps can be amine neutralized, for instance using an alkanolamine such as monoethanolamine.

The laundry detergent composition can comprises an adjunct ingredient selected from the group comprising builders including citrate, enzymes, bleach, bleach catalyst, dye, hueing dye, Leuco dyes, brightener, cleaning polymers including alkoxylated polyamines and polyethyleneimines, amphiphilic copolymers, soil release polymer, surfactant, solvent, dye transfer inhibitors, chelant, diamines, perfume, encapsulated perfume, polycarboxylates, structurant, pH trimming agents, antioxidants, antibacterial, antimicrobial agents, preservatives and mixtures thereof.

The laundry detergent composition can have a pH of from 2 to 11, preferably from 4 to 9, more preferably from 7 to 8, most preferably from 7 to 8, wherein the pH of the laundry detergent composition is measured at a 10% product concentration in demineralized water at 20° C.

The liquid laundry detergent composition can be Newtonian or non-Newtonian, preferably non-Newtonian. The liquid laundry detergent can comprise a viscosity modifier, particular suitable viscosity modifier includes ethoxylated sorbitan.

For liquid laundry detergent compositions, the composition can comprise from 5% to 99%, or from 15% to 90%, or from 25% to 80% by weight of the liquid detergent composition of water.

Structured Liquids: In some embodiments of the invention, the composition is in the form of a structured liquid. Such structured liquids can either be internally structured, whereby the structure is formed by primary ingredients (e.g. surfactant material) and/or externally structured by providing a three dimensional matrix structure using secondary ingredients (e.g. polymers, clay and/or silicate material), for use e.g. as thickeners. The composition may comprise a structurant, preferably from 0.01 wt % to 5 wt %, from 0.1 wt % to 2.0 wt % structurant. Examples of suitable structurants are given in US2006/0205631A1, US2005/0203213A1, U.S. Pat. Nos. 7,294,611, 6,855,680. The structurant is typically selected from the group consisting of diglycerides and triglycerides, ethylene glycol distearate, microcrystalline cellulose, cellulose-based materials, microfiber cellulose, hydrophobically modified alkali-swellable emulsions such as Polygel W30 (3VSigma), biopolymers, xanthan gum, gellan gum, hydrogenated castor oil, derivatives of hydrogenated castor oil such as non-ethoxylated derivatives thereof and mixtures thereof, in particular, those selected from the group of hydrogenated castor oil, derivatives of hydrogenated castor oil, microfibullar cellulose, hydroxyfunctional crystalline materials, long chain fatty alcohols, 12-hydroxystearic acids, clays and mixtures thereof. One preferred structurant is described in U.S. Pat. No. 6,855,680 which defines suitable hydroxyfunctional crystalline materials in detail. Preferred is hydrogenated castor oil. Some structurants have a thread-like structuring system having a range of aspect ratios. Another preferred structurant is based on cellulose and may be derived from a number of sources including biomass, wood pulp, citrus fibers and the like.

Pouches. In a preferred embodiment of the invention, the composition is provided in the form of a unitized dose, either tablet form or preferably in the form of a liquid/solid (optionally granules)/gel/paste held within a water-soluble film in what is known as a pouch or pod. The composition can be encapsulated in a single or multi-compartment pouch. Multi-compartment pouches are described in more detail in EP-A-2133410. When the composition is present in a multi-compartment pouch, the composition of the invention may be in one or two or more compartments, thus the dye may be present in one or more compartments, optionally all compartments. Non-shading dyes or pigments or other aesthetics may also be used in one or more compartments. In one embodiment the composition is present in a single compartment of a multi-compartment pouch.

Preferred film materials are polymeric materials. The film material can be obtained, for example, by casting, blow-molding, extrusion or blown extrusion of the polymeric material, as known in the art. Preferred polymers, copolymers or derivatives thereof suitable for use as pouch material are selected from polyvinyl alcohols, polyvinyl pyrrolidone, polyalkylene oxides, acrylamide, acrylic acid, cellulose, cellulose ethers, cellulose esters, cellulose amides, polyvinyl acetates, polycarboxylic acids and salts, polyaminoacids or peptides, polyamides, polyacrylamide, copolymers of maleic/acrylic acids, polysaccharides including starch and gelatine, natural gums such as xanthum and carragum. More preferred polymers are selected from polyacrylates and water-soluble acrylate copolymers, methylcellulose, carboxymethylcellulose sodium, dextrin, ethylcellulose, hydroxyethyl cellulose, hydroxypropyl methylcellulose, maltodextrin, polymethacrylates, and most preferably selected from polyvinyl alcohols, polyvinyl alcohol copolymers and hydroxypropyl methyl cellulose (HPMC), and combinations thereof. Preferably, the level of polymer in the pouch material, for example a PVA polymer, is at least 60%. The polymer can have any weight average molecular weight, preferably from about 1000 to 1,000,000, more preferably from about 10,000 to 300,000 yet more preferably from about 20,000 to 150,000. Mixtures of polymers can also be used as the pouch material. This can be beneficial to control the mechanical and/or dissolution properties of the compartments or pouch, depending on the application thereof and the required needs. Suitable mixtures include for example mixtures wherein one polymer has a higher water-solubility than another polymer, and/or one polymer has a higher mechanical strength than another polymer. Also suitable are mixtures of polymers having different weight average molecular weights, for example a mixture of PVA or a copolymer thereof of a weight average molecular weight of about 10,000-40,000, preferably around 20,000, and of

PVA or copolymer thereof, with a weight average molecular weight of about 100,000 to 300,000, preferably around 150,000. Also, suitable herein are polymer blend compositions, for example comprising hydrolytically degradable and water-soluble polymer blends such as polylactide and polyvinyl alcohol, obtained by mixing polylactide and polyvinyl alcohol, typically comprising about 1-35% by weight polylactide and about 65% to 99% by weight polyvinyl alcohol. Preferred for use herein are polymers which are from about 60% to about 98% hydrolysed, preferably about 80% to about 90% hydrolysed, to improve the dissolution characteristics of the material.

Naturally, different film material and/or films of different thickness may be employed in making the compartments of the present invention. A benefit in selecting different films is that the resulting compartments may exhibit different solubility or release characteristics.

Most preferred film materials are PVA films known under the MonoSol trade reference M8630, M8900, H8779 and those described in U.S. Pat. Nos. 6,166,117 and 6,787,512 and PVA films of corresponding solubility and deformability characteristics.

The film material herein can also comprise one or more additive ingredients. For example, it can be beneficial to add plasticizers, for example glycerol, ethylene glycol, diethyleneglycol, propylene glycol, sorbitol and mixtures thereof. Other additives include functional detergent additives to be delivered to the wash water, for example organic polymeric dispersants, etc.

Solid Form. As noted previously, the laundry care compositions may be in a solid form. Suitable solid forms include tablets and particulate forms, for example, granular particles, flakes or sheets. Various techniques for forming detergent compositions in such solid forms are well known in the art and may be used herein.

Fibrous Water-soluble Unit Dose Article. As used herein, the phrases “water-soluble unit dose article,” “water-soluble fibrous structure”, and “water-soluble fibrous element” mean that the unit dose article, fibrous structure, and fibrous element are miscible in water. In other words, the unit dose article, fibrous structure, or fibrous element is capable of forming a homogeneous solution with water at ambient conditions. “Ambient conditions” as used herein means 23° C. +1.0° C. and a relative humidity of 50%+2%. The water-soluble unit dose article may contain insoluble materials, which are dispersible in aqueous wash conditions to a suspension mean particle size that is less than about 20 microns, or less than about 50 microns.

The fibrous water-soluble unit dose article may include any of the disclosures found in U.S. patent application Ser. No. 15/880,594 filed on Jan. 26, 2018; U.S. patent application Ser. No. 15/880,599 filed Jan. 26, 2018; and U.S. patent application Ser. No. 15/880,604 filed Jan. 26, 2018; incorporated by reference in their entirety. Preferred water-soluble fibrous structure comprises particles having a ratio of Linear Alkylbenzene Sulfonate to Alkylethoxylated Sulfate or Alkyl Sulfate of greater than 1.

These fibrous water-soluble unit dose articles can be dissolved under various wash conditions, e.g., low temperature, low water and/or short wash cycles or cycles where consumers have been overloading the machine, especially with items having high water absorption capacities, while providing sufficient delivery of active agents for the intended effect on the target consumer substrates (with similar performance as today's liquid products). Furthermore, the water-soluble unit dose articles described herein can be produced in an economical manner by spinning fibers comprising active agents. The water-soluble unit dose articles described herein also have improved cleaning performance.

Method of Use. The compositions of this invention, prepared as hereinbefore described, can be used to form aqueous washing/treatment solutions for use in the laundering/treatment of fabrics. Generally, an effective amount of such compositions is added to water, for example in a conventional fabric automatic washing machine, to form such aqueous laundering solutions. The aqueous washing solution so formed is then contacted, typically under agitation, with the fabrics to be laundered/treated therewith. An effective amount of the liquid detergent compositions herein added to water to form aqueous laundering solutions can comprise amounts sufficient to form from about 500 to 7,000 ppm of composition in aqueous washing solution, or from about 1,000 to 3,000 ppm of the laundry care compositions herein will be provided in aqueous washing solution.

Typically, the wash liquor is formed by contacting the laundry care composition with wash water in such an amount so that the concentration of the laundry care composition in the wash liquor is from above 0 g/l to 5 g/l, or from 1 g/l, and to 4.5 g/l, or to 4.0 g/l, or to 3.5 g/l, or to 3.0 g/l, or to 2.5 g/l, or even to 2.0 g/l, or even to 1.5 g/l. The method of laundering fabric or textile may be carried out in a top-loading or front-loading automatic washing machine or can be used in a hand-wash laundry application. In these applications, the wash liquor formed and concentration of laundry detergent composition in the wash liquor is that of the main wash cycle. Any input of water during any optional rinsing step(s) is not included when determining the volume of the wash liquor.

The wash liquor may comprise 40 liters or less of water, or 30 liters or less, or 20 liters or less, or 10 liters or less, or 8 liters or less, or even 6 liters or less of water. The wash liquor may comprise from above 0 to 15 liters, or from 2 liters, and to 12 liters, or even to 8 liters of water. Typically, from 0.01 kg to 2 kg of fabric per liter of wash liquor is dosed into said wash liquor. Typically, from 0.01 kg, or from 0.05 kg, or from 0.07 kg, or from 0.10 kg, or from 0.15 kg, or from 0.20 kg, or from 0.25 kg fabric per liter of wash liquor is dosed into said wash liquor. Optionally, 50 g or less, or 45 g or less, or 40 g or less, or 35 g or less, or 30 g or less, or 25 g or less, or 20 g or less, or even 15 g or less, or even 10 g or less of the composition is contacted to water to form the wash liquor. Such compositions are typically employed at concentrations of from about 500 ppm to about 15,000 ppm in solution. When the wash solvent is water, the water temperature typically ranges from about 5° C. to about 90° C. and, when the situs comprises a fabric, the water to fabric ratio is typically from about 1:1 to about 30:1. Typically the wash liquor comprising the laundry care composition of the invention has a pH of from 3 to 11.5.

In one aspect, such method comprises the steps of optionally washing and/or rinsing said surface or fabric, contacting said surface or fabric with any composition disclosed in this specification then optionally washing and/or rinsing said surface or fabric is disclosed, with an optional drying step.

Drying of such surfaces or fabrics may be accomplished by any one of the common means employed either in domestic or industrial settings. The fabric may comprise any fabric capable of being laundered in normal consumer or institutional use conditions, and the invention is suitable for cellulosic substrates and in some aspects also suitable for synthetic textiles such as polyester and nylon and for treatment of mixed fabrics and/or fibers comprising synthetic and cellulosic fabrics and/or fibers. As examples of synthetic fabrics are polyester, nylon, these may be present in mixtures with cellulosic fibers, for example, polycotton fabrics. The solution typically has a pH of from 7 to 11, more usually 8 to 10.5. The compositions are typically employed at concentrations from 500 ppm to 5,000 ppm in solution. The water temperatures typically range from about 5° C. to about 90° C. The water to fabric ratio is typically from about 1:1 to about 30:1.

Another method includes contacting a nonwoven substrate, which is impregnated with the detergent composition, with a soiled material. As used herein, “nonwoven substrate” can comprise any conventionally fashioned nonwoven sheet or web having suitable basis weight, caliper (thickness), absorbency, and strength characteristics. Non-limiting examples of suitable commercially available nonwoven substrates include those marketed under the trade names SONTARA® by DuPont and POLY WEB® by James River Corp.

### Carbon Source of Raw Materials:

The raw materials for preparation of the surfactant, polymers and other ingredients can be based on fossil carbon or renewable carbon. Renewable carbon is a carbon source that avoid the use of fossil carbon such as natural gas, coal, petroleum. Typically, renewable carbon is derived from the biomass, carbon capture, or chemical recycling.

Biomass is a renewable carbon source formed through photosynthesis in the presence of sunlight, or chemosynthesis process in the absence of sunlight. In some cases, polymers isolated from biomass can be used directly, or further derivatized to make performance polymers. For example, the use of polysaccharide (such as starch) and derivatized polysaccharide (such as cellulose derivatives, guar derivatives, dextran derivatives) in fabric home care composition are known. In some cases, biomass can be converted into basic chemicals under certain thermal, chemical, or biological conditions. For example, bioethanol can be derived from biomass such as straw, and further convert to biobased polyethylene glycol. Other nonlimiting examples of renewable carbon from biomass include plants (e.g., sugar cane, beets, corn, potatoes, citrus fruit, woody plants, lignocellulosics, hemicellulosics, cellulosic waste), animals, animal fats, fish, bacteria, fungi, plant-based oils, and forestry products. These resources can be naturally occurring, hybrids, or genetically engineered organisms.

Carbon capture is another renewable carbon source which use various process to capture CO₂ or methane from industrial or natural processes, or directly from air (direct capture). Captured methane and CO₂ maybe converted into syngas, and/or further convert to basic chemicals, including but not limit to methanol, ethanol, fatty alcohols such as C₁₂/C₁₄ or even C₁₆/C₁₈ alcohols, other alcohols, olefins, alkanes, saturated and unsaturated organic acids, etc. These basic chemicals can used as or further convert to monomers for making transformed to usable chemicals by e.g. catalytic processes, such as the Fischer-Tropsch process or by fermentation by C₁-fixing microorganisms.

Chemical recycling is another renewable carbon source which allow plastics from waste management industry to be recycled and converted into base chemicals and chemical feedstocks. In some cases, waste plastics which cannot be re-used or mechanical recycled are convert to hydrocarbons or basic petrochemicals through gasification, pyrolysis or hydrothermal treatment processes, the hydrocarbons and basic petrochemicals can be further convert into monomers for polymers. In some cases, waste plastics are depolymerized into monomers to make new polymers. It is also possible that waste plastics are depolymerized into oligomers, the oligomers can be used as building blocks to make new polymers. The waste plastic converted by various processes to a waste plastic feedstock for the above materials may either be used alone or in combination with traditional surfactant feedstocks, such as kerosene, polyolefins derived from natural gas, coal, crude oil or even biomass, or waste fat/oil-derived paraffin and olefin, to produce biodegradable surfactants for use in detergents and other industries (thereby providing a benefit to society).

Preferably, the surfactant, polymers and other ingredients contains renewable carbon, the Renewable Carbon Index (RCI, a measure of sustainability by dividing the number of carbons derived from renewable sources by the total number of carbons in an active ingredient) of the polymer is above 10%, more preferably above 30%, more preferably above 50%, more preferably above 60%, more preferably between 70% to 100% (including 100%), and most preferably 100%.

### Embodiments of the Present Invention

1 A fabric and home care composition comprising:
(a) one or more fabric and home care ingredients; and
(b) a polyalkylenecarbonate compound comprises structural unit (II),

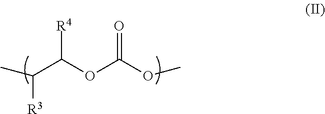

wherein, R₃ and R₄ are each independently selected from H and CH₃.

2. A composition according to embodiment 1, wherein the polyalkylenecarbonate compound has a molecular weight of from 120 to 200000, preferably from 150 to 100000, preferably from 180 to 50000, preferably from 210 to 25000, preferably from 240 to 10000, preferably from 270 to 8000, preferably from 300 to 4000, more preferably from 320 to 2000, most preferably from 350 to 1000.

3 A composition according to any preceding embodiment, wherein the total weight percentage of CO₂ (CO₂ wt %) in the polyalkylenecarbonate compound is from 5% to 70%, preferably from 10% to 60%, preferably from 15% to 55%, preferably from 20% to 50%, most preferable from 25% to 45%.

4. A composition according to any preceding embodiment, wherein the polyalkylenecarbonate compound has the following structure

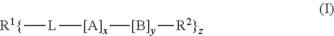

wherein:
R¹ is a residue derived from a starter compound, wherein, the starter compound is selected from monofunctional starter compound comprising from 1 to 4 carbon atoms, difunctional starter compound, multifunctional starter compound.
R² is each independently selected from H, linear or branched, substituted or unsubstituted C₁-C₄ alkyl.
L is selected from O, (C═O)—O, a single bond.
A has the following structural unit (II)

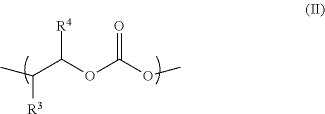

B has the following structural unit (III)

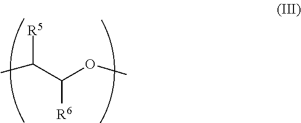

R³, R⁴, R⁵, R⁶ are each independently selected from H and CH₃.
x is integer each independently in the range of 1 to 250.
y is integer each independently in the range of 0 to 250.
z is integer each independently in the range of 1 to 20

5. A composition according to any preceding embodiment, wherein the composition comprises glycolipids surfactant, preferably selected from sophorolipids surfactant and rhamnolipids surfactant, more preferably mono-rhamnolipid surfactant.

6. A composition according to any preceding embodiment, wherein the composition comprises surfactant comprising renewable carbon, preferably surfactant selected from:
(a) surfactant comprising a C₈-C₂₂ alkyl chain and a mole average of from 1 to 40 ethoxylate units wherein at least one of the ethoxylate unit or the alkyl chain comprising carbon obtained from carbon capture; and
(b) surfactant comprising a C₈-C₂₀ alkyl chain, wherein the C₈-C₂₀ alkyl chain is produced by genetically engineered cells and microorganisms.

7. A composition according to any preceding embodiment, wherein the composition comprises alkyl benzene sulphonate (LAS) and/or secondary alkane sulfonate (SAS) surfactant, preferably greater than 50 wt % of the secondary alkane sulfonate is C₁₇ and/or C₁₈ secondary alkane sulfonate.

8. A composition according to any preceding embodiment, wherein the composition comprises C₁₂-C₁₈ methyl ester ethoxylates, preferably the C₁₂-C₁₈ methyl ester ethoxylates comprises 20% or more C₁₆-C₁₈ methyl ester ethoxylates.

9. A composition according to any preceding embodiment, wherein the composition comprises one or more surfactant selected from C₁₂ to C₁₈ alkyl ether carboxylates, fatty acid methyl ester sulfonates, furan based anionic surfactant, and citric acid ester of a C₁₆-C₁₈ monoglyceride (citrem), tartartic acid esters of a C₁₆-C₁₈ monoglyceride (tatem) and diacetyl tartaric acid ester of a C₁₆-C₁₈ monoglyceride (datem).

10. A composition according to any preceding embodiment, wherein the composition comprises a nonionic polyester soil release polymer having a structure aaccording to formula below:

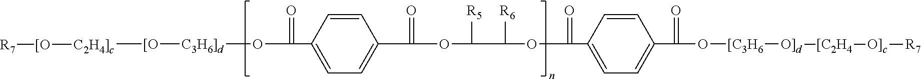

wherein:
R₅ and R₆ is independently selected from H or CH₃. More preferably, one of the R₅ and R₆ is H, and another is CH₃;
c, d are, based on molar average, a number independently selected from 0 to 200, where the sum of c+d is from 2 to 400;
more preferably, d is from 0 to 50 and c is from 1 to 200;
more preferably, d is 1 to 10 and c is 5 to 150;
R₇ is C₁-C₄ alkyl, and more preferably methyl;
n is, based on molar average, from 1 to 50, preferably 2-20, more preferably 3-12.

11. A composition according to any preceding embodiment, wherein the composition comprises a polyester soil release polymer derived from furandicarboxylic acid and/or a derivative thereof.

12. A composition according to any preceding embodiment, wherein the composition comprises EPEI, where the polyethyleneimine core has an average molecular weight (Mw) ranging from 200 to 5000 g/mol (prior to ethoxylation), and the polyoxyethylene side chains have an average of from 25 to 40 ethoxy units per side chain bonded to the polyethyleneimine backbone. Preferably the polyethyleneimine core has an average molecular weight (Mw) ranging from 1800 to 5000 g/mol (prior to ethoxylation).

13. A composition according to any preceding embodiment, wherein the composition comprises modified polyamine; preferably, amphoterically-modified oligopropyleneimine ethoxylates.

14. A composition according to any preceding embodiment, wherein the composition comprises from 0.00001 to 0.5 wt % hueing dye, preferably a hueing dye comprising a chromophore selected from the group consisting of azo, azine, anthraquinone, and triphenylmethane chromophores.

15. A composition according to any preceding embodiment, wherein the composition comprises a viscosity modifier preferable an ethoxylated sorbitan.

16. A composition according to any preceding embodiment, wherein the composition further comprises enzyme. comprises one or more selected from proteases, amylases.

17. A method of removing stain or soil from laundry, comprising a step of contacting the laundry with a fabric and home care composition according to any preceding embodiment.

### EXAMPLES

### Example 1: Half-Lives (DT50) of Inventive and Comparative Compound

Degradation is the process by which a chemical substance is broken down into smaller molecules by biotic means (biodegradability) or abiotic means (hydrolysis, photolysis, or oxidization). Half-lives (DT50) are used as measures of the stability and persistence of a chemical substance in the environment. Half-life (DT50) is defined as the time it takes for an amount of a compound to be reduced by half through degradation. It is crucial for the environmental impact, especially in the Persistent, Bioaccumulative, and Toxic (PBT) assessment. Chemicals with low aquatic DT50 values are less likely to persist in aquatic environments.

Using the Quantitative Water Persistence model [1,2] in the VEGA-Toolkit, the DT50 in water predictions for the Inventive and Comparative compound are 7 days and 82 days, respectively (Table 1).

TABLE 1

| Example | Structure (n = 15) | DT50 in water (Days) |
|---|---|---|
| Inventive compound 1 | 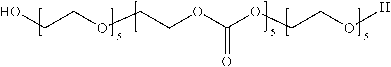 | 7 |
| Comparative compound 1 | 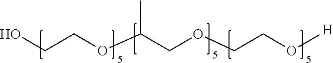 | 82 |

[1] M. Floris, A. Manganaro, O. Nicolotti, R. Medda, G. F. Mangiatordi, and E. Benfenati, A Generalizable Definition of Chemical Similarity for Read-Across, Journal of Cheminformatics 6, 39 (2014).
[2] T. Gouin, I. Cousins, and D. Mackay, Comparison of Two Methods for Obtaining Degradation Half-Lives, Chemosphere 56, 531 (2004).

### Example 2: Surface Tension (ST) of Inventive and Comparative Composition

Modern washing machines have sensors which monitor the levels of suds in the drum. If the machine senses excessive suds it continues to complete extra rinses until the suds are removed. This not only wastes water, energy & time it also impacts the freshness left on the fabrics as the extra rinses can start to wash away any perfumes. Too many suds can also stop the washing machine from pumping out the water, blocking the system and just whipping up more and more foam. Therefore, to deliver more sustainable laundry process, there is a need for composition which show:
(A). higher surface tension (ST), to enable low level of wash and/or suds. And
(B). equal/lower interfacial tension (IFT) at water-lipid interfaces, to enable equal or better cleaning, such as cleaning of lipids.

Classical molecular dynamics (MD) simulations can be used to investigate the effect of water-air interface (Tang et al. 2014). The ST and IFT of Inventive composition comprises LAS and Inventive compound 2 (7:3 molar ratio), as well as Comparative composition comprises LAS and Comparative compound 2 (7:3 molar ratio)(structures see Table 2), are predicted using simulation method as described below.

TABLE 2

| | Structures |
|---|---|
| Inventive compound 2 | 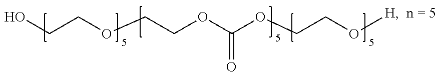 |
| Comparative compound 2 | 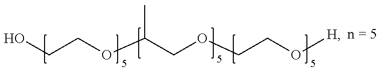 |
| LAS | 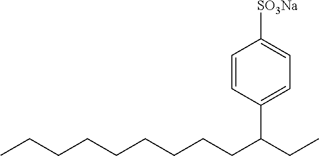 |

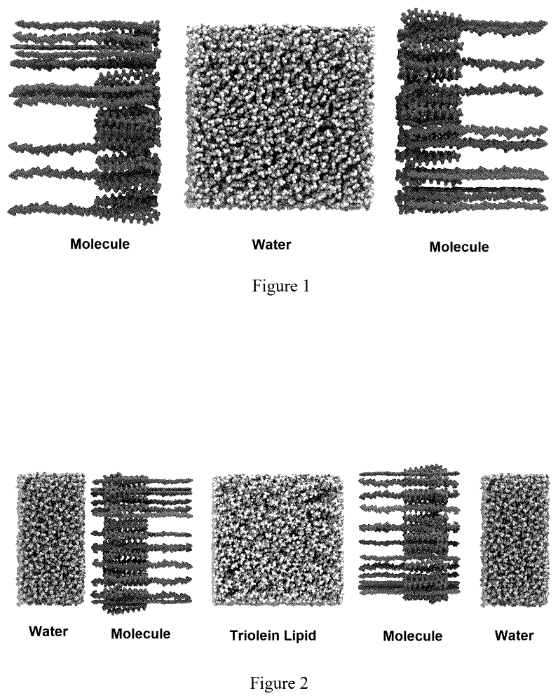

ST simulations: The initial mixed system for calculation of ST, consisted of layers of surfactant-water-surfactant, was oriented on the z-axis in a 6×6×28 nm cubic box. The water layer was positioned in the middle of the cell while the surfactant layers were on both accessible surfaces of the water layer (FIG. 1). The periodic boundary conditions were applied to have infinite surface interactions on the xy-axis and semi-isotropic pressure and temperature coupling was used to simulate water-surfactant phases. Sodium molecules were added to neutralize the net charges in the system. The MD simulations were run for two different surface concentrations of surfactant at the interface (50 and 80 molecules per 36 nm2) under NVT ensemble. The number of water molecules was 28900. MD simulations were performed using open-source GROMACS 5.1.4 and they consisted of three stages; the systems were minimized to eliminate high energies, 10 ns equilibration step was run using Berendsen thermostat (Berendsen et al. 1984) and 200 ns production step was run using Nose-Hoover thermostat (Hoover 96) at 25° C. The ST and pressure values were calculated using the pressure tensor on the z-axis according to Sresht et al. (2017). Different forcefields were combined: GAFF-Lipid for surfactant tails, GAFF for surfactant heads, OPC4 for water molecules.

IFT simulations: IFT simulations were designed in a similar manner but using unsaturated triolein lipid surface (133 residues, 22211 atoms) by orienting the systems as the layers of water-surfactant-triolein-surfactant-water on the z-axis in a 6×6×22 nm cubic box (FIG. 2). The periodic boundary conditions were also applied, and semi-isotropic pressure and temperature coupling was used to simulate three phases. Sodium molecules were added to neutralize the net charges in the system. The simulations were performed in three stages under NPT conditions: the systems were minimized to eliminate high energies, 50 ns equilibration was run using Berendsen thermostat (Bere en et al, 1984) and 100 ns production was run using Nose-Hoover thermostat (Hoover and Holian, 1996) at 25° C. and 1 atm. The IFT values were calculated using the difference between the normal pressure (P_{zz}) and the lateral pressure (P_{zz}+P_{yy}/2) pressures according to Liu et al. (2017). Different forcefields were combined: GAFF-Lipid for surfactant tails, GAFF for surfactant heads, TIP3P for water molecules.

The results for ST and IFT prediction from MD simulations are shown in Table 3 and 4.

Inventive composition comprises LAS and Inventive compound 2 show higher ST values than Comparative composition comprises LAS and Comparative compound 2. Higher ST indicate composition comprising Inventive compound could have lower wash and/or rinse suds. This result also indicates Inventive compound enable the control of wash and/or rinse suds.

At the same time, Inventive composition comprises LAS and Inventive compound 2 show equal IFT values vs Comparative composition comprises LAS and Comparative compound 2 (lower IFT trend observed for Inventive composition, not statically significant in the present simulation). Equal IFT suggest Inventive composition have parity cleaning performance versus Comparative composition.

TABLE 3

| | | Predicted ST values (mN/m) | | |
|---|---|---|---|---|
| | | 0 | 50 | 65 |
| | | molecules/ | molecules/ | molecules/ |
| Surfactant system | | 36 nm² | 36 nm² | 36 nm² |
| Inventive | LAS + Inventive | 70.66 | 63.21 | 52.20 |
| composition | compound 2 | (±0.20) | (±3.13) | (±2.50) |
| | (7:3 molar ratio) | | | |
| Comparative | LAS + Comparative | 70.66 | 52.42 | 33.13 |
| composition | compound 2 | (±0.20) | (±2.20) | (±3.16) |
| | (7:3 molar ratio) | | | |

TABLE 4

| | | Predicted IFT values (mN/m) | | |
|---|---|---|---|---|
| | | 0 | 50 | 65 |
| | | molecules/ | molecules/ | molecules/ |
| Surfactant system | | 36 nm² | 36 nm² | 36 nm² |
| Inventive | LAS + Inventive | 31.96 | 13.16 | 0.43 |
| composition | compound 2 | (±0.92) | (±2.87) | (±4.56) |
| | (7:3 molar ratio) | | | |
| Comparative | LAS + Comparative | 31.96 | 13.90 | 4.86 |
| composition | compound 2 | (±0.92) | (±3.90) | (±4.68) |
| | (7:3 molar ratio) | | | |

### REFERENCES

Berendsen H. J. C., Postma J. P. M., van Gunsteren W. F., DiNola A. and Haak J. R., Molecular dynamics with coupling to an external bath, J. Chem. Phys. 81, 3684 (1984)
Hoover W. G. and Holian B. L., Kinetic Moments Method for the Canonical Ensemble Disbution, Physics Letters A 211, 253-257 (1996).
Liu Z., Wang C., Zhou H., Wang Y., Zhang L., Zhang L and Zhao S., Characterising the Impact of Surfactant Structure on Interfacial Tension: A Molecular Dynamics Study.
Sresht V., Lewandowski E. P., Blankschtein D. and Jusufi A., Combined Molecular Dynamics Simulation-Molecular-Thermodynamic Theory Framework for Predicting Surface Tensions, Langmuir, 33, 33, 8319-8329 (2017).
Tang, X., Huston K. J, and Larson R. G., Molecular Dynamics Simulations of Structure-Property Relationships of Tween 80 Surfactants in Water and at Interfaces, J. Phys. Chem. B, 118, 45, 12907-12918 (2014)

1. A fabric and home care composition comprising:
(a) one or more fabric and home care ingredients; and
(b) a polyalkylenecarbonate compound comprises structural unit (II), 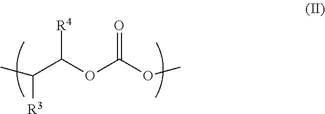
wherein, R³ and R⁴ are each independently selected from H and CH₃.

2. A composition according to claim 1, wherein the polyalkylenecarbonate compound has a molecular weight of from about 120 to about 200000.

3. A composition according to claim 1, wherein the total weight percentage of CO₂ (CO₂ wt %) in the polyalkylenecarbonate compound is from about 5% to about 70%.

4. A composition according claim 1, wherein the polyalkylenecarbonate compound has the following structure 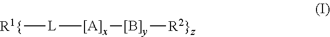
wherein:
R¹ is a residue derived from a starter compound, wherein, the starter compound is selected from monofunctional starter compound comprising from 1 to 4 carbon atoms, difunctional starter compound, multifunctional starter compound.
R² is each independently selected from H, linear or branched, substituted or unsubstituted C₁-C₄ alkyl.
L is selected from O, (C═O)—O, a single bond.
A has the following structural unit (II) 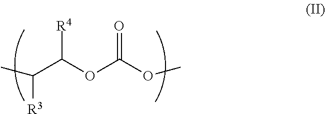
B has the following structural unit (III) 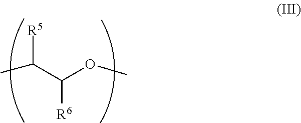
R³, R⁴, R⁵, R⁶ are each independently selected from H and CH₃.
x is integer each independently in the range of 1 to 250.
y is integer each independently in the range of 0 to 250.
z is integer each independently in the range of 1 to 20.

5. A composition according to claim 1, wherein the composition comprises glycolipids surfactant, selected from sophorolipids surfactant and rhamnolipids surfactant, more mono-rhamnolipid surfactant.

6. A composition according to claim 1, wherein the composition comprises surfactant comprising renewable carbon, surfactant selected from:
(a) surfactant comprising a C₈-C₂₂ alkyl chain and a mole average of from 1 to 40 ethoxylate units wherein at least one of the ethoxylate unit or the alkyl chain comprising carbon obtained from carbon capture; and
(b) surfactant comprising a C₈-C₂₀ alkyl chain, wherein the C₈-C₂₀ alkyl chain is produced by genetically engineered cells and microorganisms.

7. A composition according to claim 1, wherein the composition comprises alkyl benzene sulphonate (LAS) and/or secondary alkane sulfonate (SAS) surfactant, greater than about 50 wt % of the secondary alkane sulfonate is C₁₇ and/or C₁₈ secondary alkane sulfonate.

8. A composition according to claim 1, wherein the composition comprises C₁₂-C₁₈ methyl ester ethoxylates, the C₁₂-C₁₈ methyl ester ethoxylates comprises about 20% or more C₁₆-C₁₈ methyl ester ethoxylates.

9. A composition according to claim 1, wherein the composition comprises one or more surfactant selected from C₁₂ to C₁₈ alkyl ether carboxylates, fatty acid methyl ester sulfonates, furan based anionic surfactant, and citric acid ester of a C₁₆-C₁₈ monoglyceride (citrem), tartartic acid esters of a C₁₆-C₁₈ monoglyceride (tatem) and diacetyl tartaric acid ester of a C₁₆-C₁₈ monoglyceride (datem).

10. A composition according to claim 1, wherein the composition comprises a nonionic polyester soil release polymer having a structure according to formula below: 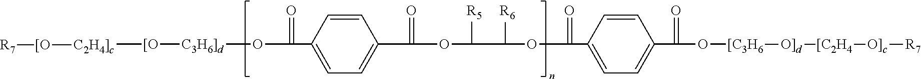
wherein:
R₅ and R₆ is independently selected from H or CH₃. More, one of the R₅ and R₆ is H, and another is CH₃;
c, d are, based on molar average, a number independently selected from about 0 to about 200, where the sum of c+d is from about 2 to about 400;
more, d is from about 0 to about 50 and c is from about 1 to about 200;
more, d is about 1 to about 10 and c is about 5 to about 150;
R₇ is C₁-C₄ alkyl, and more methyl;
n is, based on molar average, from about 1 to about 50, about 2-20, more about 3-12.

11. A composition according to claim 1, wherein the composition comprises a polyester soil release polymer derived from furandicarboxylic acid and/or a derivative thereof.

12. A composition according to claim 1, wherein the composition comprises EPEI, where the polyethyleneimine core has an average molecular weight (Mw) ranging from about 200 to about 5000 g/mol (prior to ethoxylation), and the polyoxyethylene side chains have an average of from about 25 to about 40 ethoxy units per side chain bonded to the polyethyleneimine backbone, the polyethyleneimine core has an average molecular weight (Mw) ranging from about 1800 to about 5000 g/mol (prior to ethoxylation).

13. A composition according to claim 1, wherein the composition comprises modified polyamine;, amphoterically-modified oligopropyleneimine ethoxylates.

14. A composition according to claim 1, wherein the composition comprises from about 0.00001 to about 0.5 wt % hueing dye, a hueing dye comprising a chromophore selected from the group consisting of azo, azine, anthraquinone, and triphenylmethane chromophores.

15. A composition according to claim 1, wherein the composition comprises a viscosity modifier.

1. A fabric and home care composition comprising:
(a) one or more fabric and home care ingredients; and
(b) a polyalkylenecarbonate compound comprises structural unit (II), 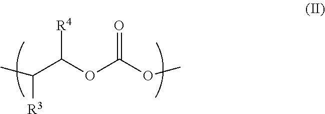
wherein, R³ and R⁴ are each independently selected from H and CH₃.

2. A composition according to claim 1, wherein the polyalkylenecarbonate compound has a molecular weight of from about 120 to about 200000.

3. A composition according to claim 1, wherein the total weight percentage of CO₂ (CO₂ wt %) in the polyalkylenecarbonate compound is from about 5% to about 70%.

4. A composition according claim 1, wherein the polyalkylenecarbonate compound has the following structure 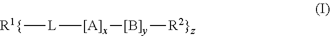
wherein:
R₁ is a residue derived from a starter compound, wherein, the starter compound is selected from monofunctional starter compound comprising from 1 to 4 carbon atoms, difunctional starter compound, multifunctional starter compound.
R² is each independently selected from H, linear or branched, substituted or unsubstituted C₁-C₄ alkyl.
L is selected from O, (C═O)—O, a single bond.
A has the following structural unit (II) 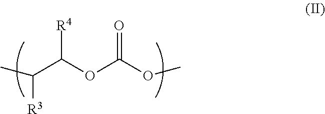
B has the following structural unit (III) 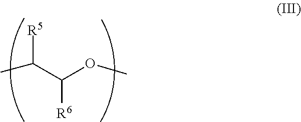
R₃, R₄, R₅, R₆ are each independently selected from H and CH₃.
x is integer each independently in the range of 1 to 250.
y is integer each independently in the range of 0 to 250.
z is integer each independently in the range of 1 to 20.

5. A composition according to claim 1, wherein the composition comprises glycolipids surfactant, selected from sophorolipids surfactant and rhamnolipids surfactant, more mono-rhamnolipid surfactant.

6. A composition according to claim 1, wherein the composition comprises surfactant comprising renewable carbon, surfactant selected from:
(a) surfactant comprising a C₈-C₂₂ alkyl chain and a mole average of from 1 to 40 ethoxylate units wherein at least one of the ethoxylate unit or the alkyl chain comprising carbon obtained from carbon capture; and
(b) surfactant comprising a C₈-C₂₀ alkyl chain, wherein the C₈-C₂₀ alkyl chain is produced by genetically engineered cells and microorganisms.

7. A composition according to claim 1, wherein the composition comprises alkyl benzene sulphonate (LAS) and/or secondary alkane sulfonate (SAS) surfactant, greater than about 50 wt % of the secondary alkane sulfonate is C₁₇ and/or C₁₈ secondary alkane sulfonate.

8. A composition according to claim 1, wherein the composition comprises C₁₂-C₁₈ methyl ester ethoxylates, the C₁₂-C₁₈ methyl ester ethoxylates comprises about 20% or more C₁₆-C₁₈ methyl ester ethoxylates.

9. A composition according to claim 1, wherein the composition comprises one or more surfactant selected from C₁₂ to C₁₈ alkyl ether carboxylates, fatty acid methyl ester sulfonates, furan based anionic surfactant, and citric acid ester of a C₁₆-C₁₈ monoglyceride (citrem), tartartic acid esters of a C₁₆-C₁₈ monoglyceride (tatem) and diacetyl tartaric acid ester of a C₁₆-C₁₈ monoglyceride (datem).

10. A composition according to claim 1, wherein the composition comprises a nonionic polyester soil release polymer having a structure according to formula below: 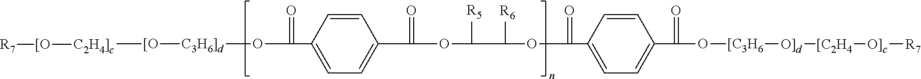
wherein:
R₅ and R₆ is independently selected from H or CH₃. More, one of the R₅ and R₆ is H, and another is CH₃;
c, d are, based on molar average, a number independently selected from about 0 to about 200, where the sum of c+d is from about 2 to about 400;
more, d is from about 0 to about 50 and c is from about 1 to about 200;
more, d is about 1 to about 10 and c is about 5 to about 150;
R₇ is C₁-C₄ alkyl, and more methyl;
n is, based on molar average, from about 1 to about 50, about 2-20, more about 3-12.

11. A composition according to claim 1, wherein the composition comprises a polyester soil release polymer derived from furandicarboxylic acid and/or a derivative thereof.

12. A composition according to claim 1, wherein the composition comprises EPEI, where the polyethyleneimine core has an average molecular weight (Mw) ranging from about 200 to about 5000 g/mol (prior to ethoxylation), and the polyoxyethylene side chains have an average of from about 25 to about 40 ethoxy units per side chain bonded to the polyethyleneimine backbone, the polyethyleneimine core has an average molecular weight (Mw) ranging from about 1800 to about 5000 g/mol (prior to ethoxylation).

13. A composition according to claim 1, wherein the composition comprises modified polyamine;, amphoterically-modified oligopropyleneimine ethoxylates.

14. A composition according to claim 1, wherein the composition comprises from about 0.00001 to about 0.5 wt % hueing dye, a hueing dye comprising a chromophore selected from the group consisting of azo, azine, anthraquinone, and triphenylmethane chromophores.

15. A composition according to claim 1, wherein the composition comprises a viscosity modifier.
